(19) United States
(12) Patent Application Publication
(10) Pub. No.: US 2009/0132419 A1
(43) Pub. Date: May 21, 2009

(54) OBFUSCATING SENSITIVE DATA WHILE PRESERVING DATA USABILITY

(76) Inventors: Garland Grammer, Jackson, NJ (US); Shallin Joshi, Brookfield, CT (US); William Kroeschel, Jackson, NJ (US); Sudir Kumar, New Delhi (IN); Arvind Sathi, Englewood, CO (US); Mahesh Viswanathan, Yorktown Heights, NY (US)

Correspondence Address: SCHMEISER, OLSEN & WATTS, 22 CENTURY HILL DRIVE, SUITE 302, LATHAM, NY, 12110, US

(21) Appl. No.: 11/940,401

(22) Filed: Nov. 15, 2007

(51) Int. Cl. H04L 9/00

(52) U.S. Cl. 705/50

(57) ABSTRACT

A method and system for obfuscating sensitive data while preserving data usability. The in-scope data files of an application are identified. The in-scope data files include sensitive data that must be masked to preserve its confidentiality. Data definitions are collected. Primary sensitive data fields are identified. Data names for the primary sensitive data fields are normalized. The primary sensitive data fields are classified according to sensitivity. Appropriate masking methods are selected from a pre-defined set to be applied to each data element based on rules exercised on the data. The data being masked is profiled to detect invalid data. Masking software is developed and input considerations are applied. The selected masking method is executed and operational and functional validation is performed.

### FIELD OF THE INVENTION

The present invention relates to a method and system for obfuscating sensitive data and more particularly to a technique for masking sensitive data to secure end user confidentiality and/or network security while preserving data usability across software applications.

### BACKGROUND

Across various industries, sensitive data (e.g., data related to customers, patients, or suppliers) is shared outside secure corporate boundaries. Initiatives such as outsourcing and off-shoring have created opportunities for this sensitive data to become exposed to unauthorized parties, thereby placing end user confidentiality and network security at risk. In many cases, these unauthorized parties do not need the true data value to conduct their job functions. Examples of sensitive data include, but are not limited to, names, addresses, network identifiers, social security numbers and financial data. Conventionally, data masking techniques for protecting such sensitive data are developed manually and implemented independently in an ad hoc and subjective manner for each application. Such an ad hoc data masking approach requires time-consuming iterative trial and error cycles that are not repeatable. Further, multiple subject matter experts using the aforementioned subjective data masking approach independently develop and implement inconsistent data masking techniques on multiple interfacing applications that may work effectively when the applications are operated independently of each other. When data is exchanged between the interfacing applications, however, data inconsistencies introduced by the inconsistent data masking techniques produce operational and/or functional failure. Still further, conventional masking approaches simply replace sensitive data with non-intelligent and repetitive data (e.g., replace alphabetic characters with XXXX and numeric characters to 99999, or replace characters that are selected with a randomization scheme), leaving test data with an absence of meaningful data. Because meaningful data is lacking, not all paths of logic in the application are tested (i.e., full functional testing is not possible), leaving the application vulnerable to error when true data values are introduced in production. Thus, there exists a need to overcome at least one of the preceding deficiencies and limitations of the related art.

### SUMMARY OF THE INVENTION

In a first embodiment, the present invention provides a method of obfuscating sensitive data while preserving data usability, comprising:

identifying a scope of a first business application, wherein the scope includes a plurality of pre-masked in-scope data files that include a plurality of data elements, and wherein one or more data elements of the plurality of data elements include a plurality of data values being input into the first business application;

identifying a plurality of primary sensitive data elements as being a subset of the plurality of data elements, wherein a plurality of sensitive data values is included in one or more primary sensitive data elements of the plurality of primary sensitive data elements, wherein the plurality of sensitive data values is a subset of the plurality of data values, wherein any sensitive data value of the plurality of sensitive data values is associated with a security risk that exceeds a predetermined risk level;

selecting a masking method from a set of pre-defined masking methods based on one or more rules exercised on a primary sensitive data element of the plurality of primary sensitive data elements, wherein the primary sensitive data element includes one or more sensitive data values of the plurality of sensitive data values; and

executing, by a computing system, software that executes the masking method, wherein the executing of the software includes masking the one or more sensitive data values, wherein the masking includes transforming the one or more sensitive data values into one or more desensitized data values that are associated with a security risk that does not exceed the predetermined risk level, wherein the masking is operationally valid, wherein a processing of the one or more desensitized data values as input to the first business application is functionally valid, wherein a processing of the one or more desensitized data values as input to a second business application is functionally valid, and wherein the second business application is different from the first business application.

A system, computer program product, and a process for supporting computing infrastructure that provides at least one support service corresponding to the above-summarized method are also described and claimed herein.

In a second embodiment, the present invention provides a method of obfuscating sensitive data while preserving data usability, comprising:

identifying a scope of a first business application, wherein the scope includes a plurality of pre-masked in-scope data files that include a plurality of data elements, and wherein one or more data elements of the plurality of data elements includes a plurality of data values being input into the first business application;

storing a diagram of the scope of the first business application as an object in a data analysis matrix managed by a software tool, wherein the diagram includes a representation of the plurality of pre-masked in-scope data files;

collecting a plurality of data definitions of the plurality of pre-masked in-scope data files, wherein the plurality of data definitions includes a plurality of attributes that describe the plurality of data elements;

storing the plurality of attributes in the data analysis matrix;

identifying a plurality of primary sensitive data elements as being a subset of the plurality of data elements, wherein a plurality of sensitive data values is included in one or more primary sensitive data elements of the plurality of primary sensitive data elements, wherein the plurality of sensitive data values is a subset of the plurality of data values, wherein any sensitive data value of the plurality of sensitive data values is associated with a security risk that exceeds a predetermined risk level;

storing, in the data analysis matrix, a plurality of indicators of the primary sensitive data elements included in the plurality of primary sensitive data elements;

normalizing a plurality of data element names of the plurality of primary sensitive data elements, wherein the normalizing includes mapping the plurality of data element names to a plurality of normalized data element names, and wherein a number of normalized data element names in the plurality of normalized data element names is less than a number of data element names in the plurality of data element names;

storing, in the data analysis matrix, a plurality of indicators of the normalized data element names included in the plurality of normalized data element names;

classifying the plurality of primary sensitive data elements in a plurality of data sensitivity categories, wherein the classifying includes associating, in a many-to-one correspondence, the primary sensitive data elements included in the plurality of primary sensitive data elements with the data sensitivity categories included in the plurality of data sensitivity categories;

identifying a subset of the plurality of primary sensitive data elements based on the subset of the plurality of primary sensitive data elements being classified in one or more data sensitivity categories of the plurality of data sensitivity categories;

storing, in the data analysis matrix, a plurality of indicators of the data sensitivity categories included in the plurality of data sensitivity categories;

selecting a masking method from a set of pre-defined masking methods based on one or more rules exercised on a primary sensitive data element of the plurality of primary sensitive data elements, wherein the selecting the masking method is included in an obfuscation approach, wherein the primary sensitive data element is included in the subset of the plurality of primary sensitive data elements, and wherein the primary sensitive data element includes one or more sensitive data values of the plurality of sensitive data values;

storing, in the data analysis matrix, one or more indicators of the one or more rules, wherein the storing the one or more indicators of the one or more rules includes associating the one or more rules with the primary sensitive data element;

validating the obfuscation approach, wherein the validating the obfuscation approach includes:
analyzing the data analysis matrix;
analyzing the diagram of the scope of the first business application; and
adding data to the data analysis matrix, in response to the analyzing the data analysis matrix and the analyzing the diagram;

profiling, by a software-based data analyzer tool, a plurality of actual values of the plurality of sensitive data elements, wherein the profiling includes:

identifying one or more patterns in the plurality of actual values, and determining a replacement rule for the masking method based on the one or more patterns;

developing masking software by a software-based data masking tool, wherein the developing the masking software includes:
creating metadata for the plurality of data definitions;
invoking a reusable masking algorithm associated with the masking method; and
invoking a plurality of reusable reporting jobs that report a plurality of actions taken on the plurality of primary sensitive data elements, report any exceptions generated by the method of obfuscating sensitive data, and report a plurality of operational statistics associated with an execution of the masking method;

customizing a design of the masking software, wherein the customizing includes applying one or more considerations associated with a performance of a job that executes the masking software;

developing the job that executes the masking software;

developing a first validation procedure;

developing a second validation procedure;

executing, by a computing system, the job that executes the masking software, wherein the executing of the job includes masking the one or more sensitive data values, wherein the masking the one or more sensitive data values includes transforming the one or more sensitive data values into one or more desensitized data values that are associated with a security risk that does not exceed the predetermined risk level;

executing the first validation procedure, wherein the executing the first validation procedure includes determining that the job is operationally valid;

executing the second validation procedure, wherein the executing the second validation procedure includes determining that a processing of the one or more desensitized data values as input to the first business application is functionally valid; and

processing the one or more desensitized data values as input to a second business application, wherein the processing the one or more desensitized data values as input to the second business application is functionally valid, and wherein the second business application is different from the first business application.

### BRIEF DESCRIPTION OF THE DRAWINGS

FIG. 1 is a block diagram of a system for obfuscating sensitive data while preserving data usability, in accordance with embodiments of the present invention.

FIGS. 2A-2B depict a flow diagram of a data masking process implemented by the system of FIG. 1, in accordance with embodiments of the present invention.

FIG. 3 depicts a business application's scope that is identified in the process of FIGS. 2A-2B, in accordance with embodiments of the present invention.

FIG. 4 depicts a mapping between non-normalized data names and normalized data names that is used in a normalization step of the process of FIGS. 2A-2B, in accordance with embodiments of the present invention.

FIG. 5 is a table of data sensitivity classifications used in a classification step of the process of FIGS. 2A-2B, in accordance with embodiments of the present invention.

FIG. 6 is a table of masking methods from which an algorithm is selected in the process of FIGS. 2A-2B, in accordance with embodiments of the present invention.

FIG. 7 is a table of default masking methods selected for normalized data names in the process of FIGS. 2A-2B, in accordance with embodiments of the present invention.

FIG. 8 is a flow diagram of a rule-based masking method selection process included in the process of FIGS. 2A-2B, in accordance with embodiments of the present invention.

FIG. 9 is a block diagram of a data masking job used in the process of FIGS. 2A-2B, in accordance with embodiments of the present invention.

FIG. 10 is an exemplary application scope diagram identified in the process of FIGS. 2A-2B, in accordance with embodiments of the present invention.

FIGS. 11A-11D depict four tables that include exemplary data elements and exemplary data definitions that are collected in the process of FIGS. 2A-2B, in accordance with embodiments of the present invention.

FIGS. 12A-12C collectively depict an excerpt of a data analysis matrix included in the system of FIG. 1 and populated by the process of FIGS. 2A-2B, in accordance with embodiments of the present invention.

FIG. 13 depicts a table of exemplary normalizations performed on the data elements of FIGS. 11A-11D, in accordance with embodiments of the present invention.

FIGS. 14A-14C collectively depict an excerpt of masking method documentation used in an auditing step of the process of FIGS. 2A-2B, in accordance with embodiments of the present invention.

FIG. 15 is a block diagram of a computing system that includes components of the system of FIG. 1 and that implements the process of FIGS. 2A-2B, in accordance with embodiments of the present invention.

### DETAILED DESCRIPTION OF THE INVENTION

### Overview

The present invention provides a method that may include identifying the originating location of data per business application, analyzing the identified data for sensitivity, determining business rules and/or information technology (IT) rules that are applied to the sensitive data, selecting a masking method based on the business and/or IT rules, and executing the selected masking method to replace the sensitive data with fictional data for storage or presentation purposes. The execution of the masking method outputs realistic, desensitized (i.e., non-sensitive) data that allows the business application to remain fully functional. In addition, one or more actors (i.e., individuals and/or interfacing applications) that may operate on the data delivered by the business application are able to function properly. Moreover, the present invention may provide a consistent and repeatable data masking (a.k.a. data obfuscation) process that allows an entire enterprise to execute the data masking solution across different applications.

### Data Masking System

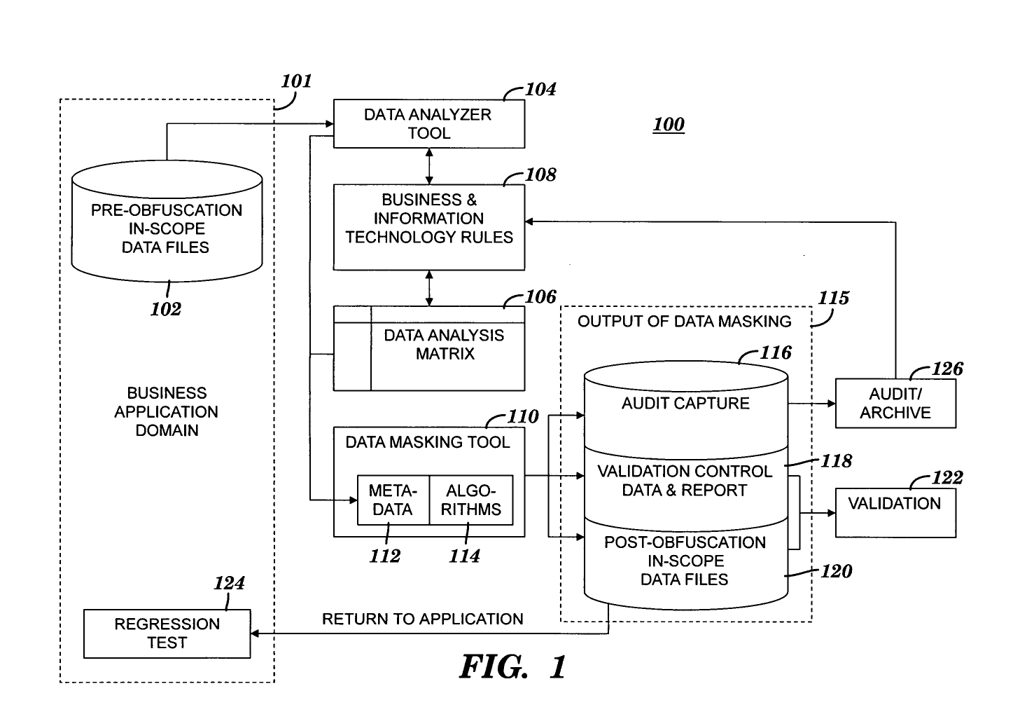

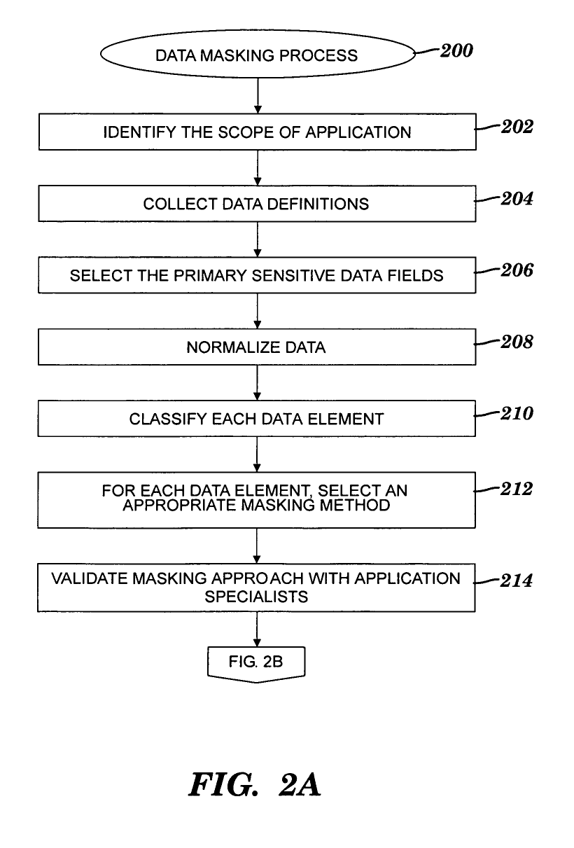

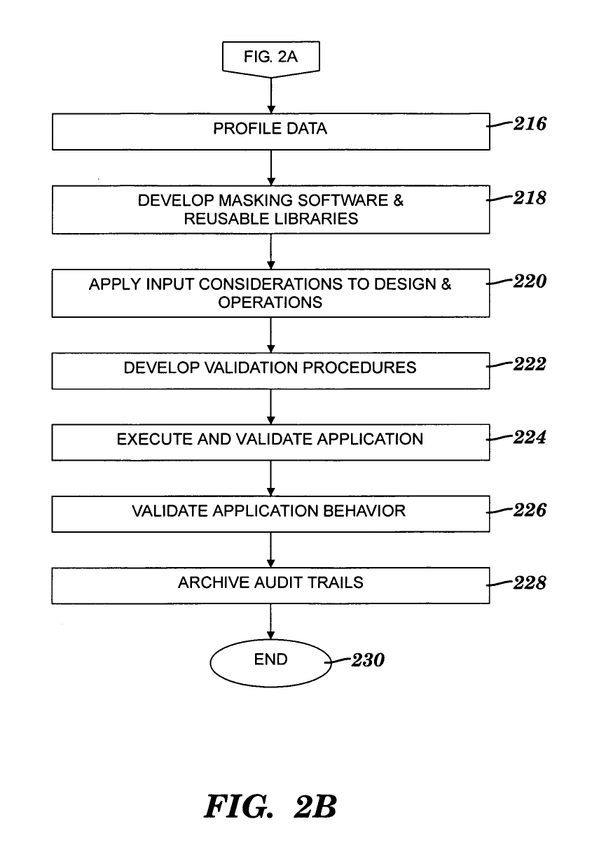

FIG. 1 is a block diagram of a system 100 for masking sensitive data while preserving data usability, in accordance with embodiments of the present invention. In one embodiment, system 100 is implemented to mask sensitive data while preserving data usability across different software applications. System 100 includes a domain 101 of a software-based business application (hereinafter, referred to simply as a business application). Domain 101 includes pre-obfuscation in-scope data files 102. System 100 also includes a data analyzer tool 104, a data analysis matrix 106, business & information technology rules 108, and a data masking tool 110 which includes metadata 112 and a library of pre-defined masking algorithms 114. Furthermore, system 100 includes output 115 of a data masking process (see FIGS. 2A-2B). Output 115 includes reports in an audit capture repository 116, a validation control data & report repository 118 and post-obfuscation in-scope data files 120.

Pre-obfuscation in-scope data files 102 include pre-masked data elements (a.k.a. data elements being masked) that contain pre-masked data values (a.k.a. pre-masked data or data being masked) (i.e., data that is being input to the business application and that needs to be masked to preserve confidentiality of the data). One or more business rules and/or one or more IT rules in rules 108 are exercised on at least one pre-masked data element.

Data masking tool 110 utilizes masking methods in algorithms 114 and metadata 112 for data definitions to transform the pre-masked data values into masked data values (a.k.a. masked data or post-masked data) that are desensitized (i.e., that have a security risk that does not exceed a predetermined risk level). Analysis performed in preparation of the transformation of pre-masked data by data masking tool 110 is stored in data analysis matrix 106. Data analyzer tool 104 performs data profiling that identifies invalid data after a masking method is selected. Reports included in output 115 may be displayed on a display screen (not shown) or may be included on a hard copy report. Additional details about the functionality of the components and processes of system 100 are described in the section entitled Data Masking Process.

Data analyzer tool 104 may be implemented by IBM® WebSphere® Information Analyzer, a data analyzer software tool offered by International Business Machines Corporation located in Armonk, N.Y. York. Data masking tool 110 may be implemented by IBM® WebSphere® DataStage offered by International Business Machines Corporation.

Data analysis matrix 106 is managed by a software tool (not shown). The software tool that manages data analysis matrix 106 may be implemented as a spreadsheet tool such as an Excel® spreadsheet tool.

### Data Masking Process

FIGS. 2A-2B depict a flow diagram of a data masking process implemented by the system of FIG. 1, in accordance with embodiments of the present invention. The data masking process begins at step 200 of FIG. 2A. In step 202, one or more members of an IT support team identify the scope (a.k.a. context) of a business application (i.e., a software application). As used herein, an IT support team includes individuals having IT skills that either support the business application or support the creation and/or execution of the data masking process of FIGS. 2A-2B. The IT support team includes, for example, a project manager, IT application specialists, a data analyst, a data masking solution architect, a data masking developer and a data masking operator.

The one or more members of the IT support team who identify the scope in step 202 are, for example, one or more subject matter experts (e.g., an application architect who understands the end-to-end data flow context in the environment in which data obfuscation is to take place). Hereinafter, the business application whose scope is identified in step 202 is referred to simply as “the application.” The scope of the application defines the boundaries of the application and its isolation from other applications. The scope of the application is functionally aligned to support a business process (e.g., Billing, Inventory Management, or Medical Records Reporting). The scope identified in step 202 is also referred to herein as the scope of data obfuscation analysis.

In step 202, a member of the IT support team (e.g., an IT application expert) maps out relationships between the application and other applications to identify a scope of the application and to identify the source of the data to be masked. Identifying the scope of the application in step 202 includes identifying a set of data from pre-obfuscation in-scope data files 102 (see FIG. 1) that needs to be analyzed in the subsequent steps of the data masking process. Further, step 202 determines the processing boundaries of the application relative to the identified set of data. Still further, regarding the data in the identified set of data, step 202 determines how the data flows and how the data is used in the context of the application. In step 202, the software tool (e.g., spreadsheet tool) managing data analysis matrix 106 (see FIG. 1) stores a diagram (a.k.a. application scope diagram) as an object in data analysis matrix 106. The application scope diagram illustrates the scope of the application and the source of the data to be masked. For example, the software tool that manages data analysis matrix 106 stores the application scope diagram as a tab in a spreadsheet file that includes another tab for data analysis matrix 106 (see FIG. 1).

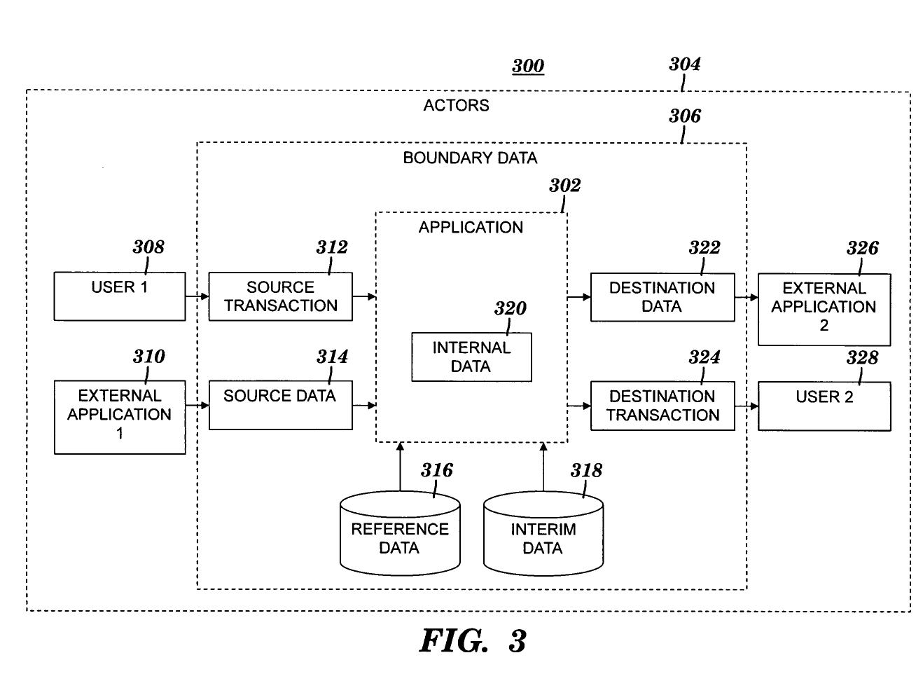

An example of the application scope diagram received in step 202 is diagram 300 in FIG. 3. Diagram 300 includes application 302 at the center of a universe that includes an actors layer 304 and a boundary data layer 306. Actors layer 304 includes the people and processes that provide data to or receive data from application 302. People providing data to application 302 include a first user 308 and a process providing data to application 302 include a first external application 310.

The source of data to be masked lies in boundary data layer 306, which includes:

1. A source transaction 312 of first user 308. Source transaction 312 is directly input to application 302 through a communications layer. Source transaction 312 is one type of data that is an initial candidate for masking.

2. Source data 314 of external application 310 is input to application 302 as batch or via a real time interface. Source data 314 is an initial candidate for masking.

3. Reference data 316 is used for data lookup and contains a primary key and secondary information that relates to the primary key. Keys to reference data 316 may be sensitive and require referential integrity, or the cross reference data may be sensitive. Reference data 316 is an initial candidate for masking.

4. Interim data 318 is data that can be input and output, and is solely owned by and used within application 302. Examples of uses of interim data include suspense or control files. Interim data 318 is typically derived from source data 314 or reference data 316 and is not a masking candidate. In a scenario in which interim data 318 existed before source data 314 was masked, such interim data must be considered a candidate for masking.

5. Internal data 320 flows within application 302 from one sub-process to the next sub-process. Provided the application 302 is not split into independent sub-set parts for test isolation, internal data 320 is not a candidate for masking.

6. Destination data 322 and destination transaction 324, which are output from application 302 and received by a second application 326 and a second user 328, respectively, are not candidates for masking in the scope of application 302. When data is masked from source data 314 and reference data 316, masked data flows into destination data 322. Such boundary destination data is, however, considered as source data for one or more external applications (e.g., external application 326).

Returning to the process of FIG. 2A, once the application scope is fully identified and understood in step 202, and the boundary data files and transactions are identified in step 202, data definitions are acquired for analysis in step 204. In step 204, one or more members of the IT support team (e.g., one or more IT application experts and/or one or more data analysts) collect data definitions of all of the in-scope data files identified in step 202. Data definitions are finite properties of a data file and explicitly identify the set of data elements on the data file or transaction that can be referenced from the application. Data definitions may be program-defined (i.e., hard coded) or found in, for example, Cobol Copybooks, Database Data Definition Language (DDL), metadata, Information Management System (IMS) Program Specification Blocks (PSBs), Extensible Markup Language (XML) Schema or another software-specific definition.

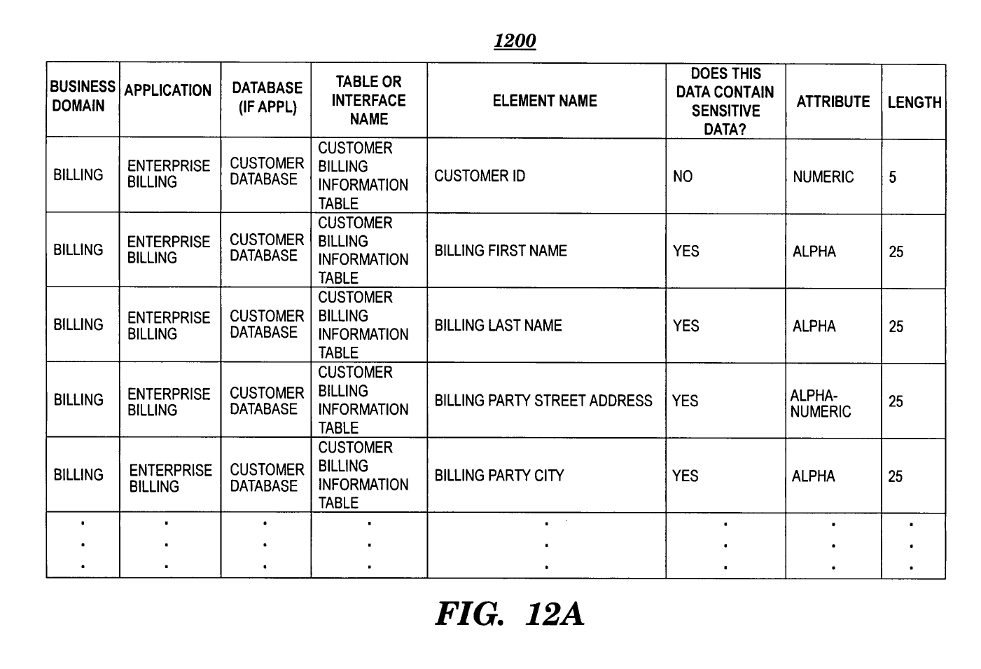

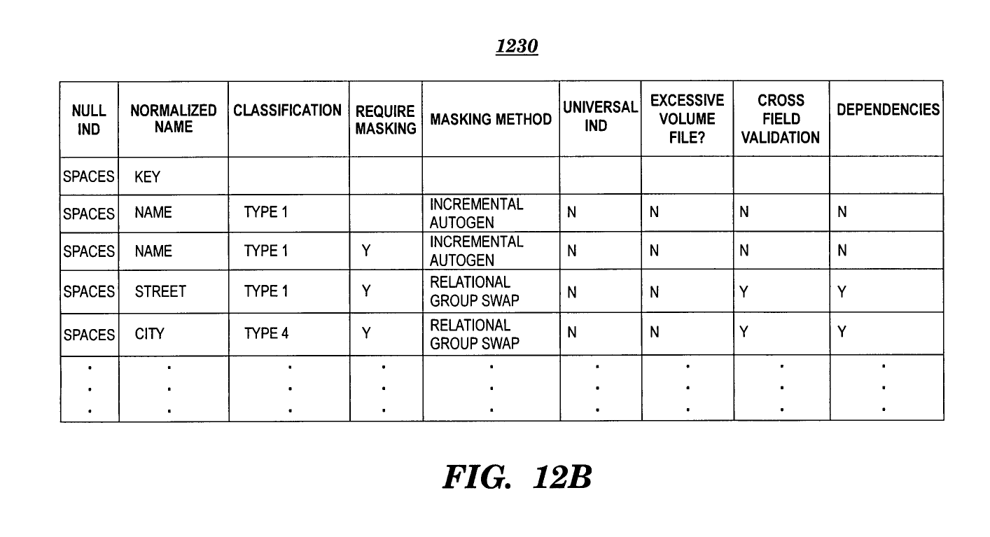

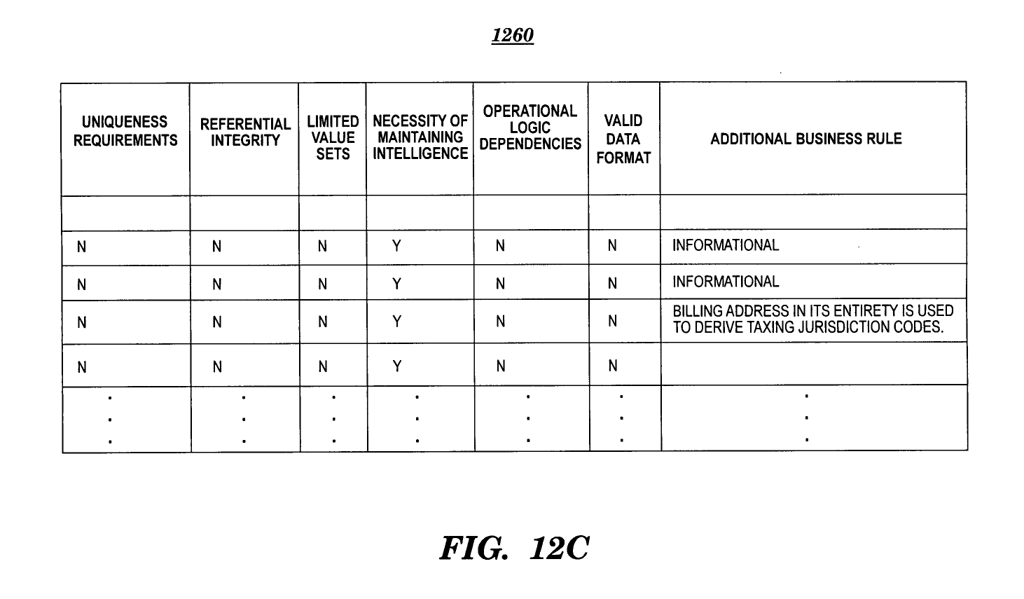

Each data element (a.k.a. element or data field) in the in-scope data files 102 (see FIG. 1) is organized in data analysis matrix 106 (see FIG. 1) that serves as the primary artifact in the requirements developed in subsequent steps of the data masking process. In step 204, the software tool (e.g., spreadsheet tool) managing data analysis matrix 106 (see FIG. 1) receives data entries having information related to business application domain 101 (see FIG. 1), the application (e.g., application 302 of FIG. 3) and identifiers and attributes of the data elements being organized in data analysis matrix 106 (see FIG. 1). This organization in data analysis matrix 106 (see FIG. 1) allows for notations on follow-up questions, categorization, etc. Supplemental information that is captured in data analysis matrix 106 (see FIG. 1) facilitates a more thorough analysis in the data masking process. An excerpt of a sample of data analysis matrix 106 (see FIG. 1) is shown in FIGS. 12A-12C.

In step 206, one or more members of the IT support team (e.g., one or more data analysts and/or one or more IT application experts) manually analyze each data element in the pre-obfuscation in-scope data files 102 (see FIG. 1) independently, select a subset of the data fields included the in-scope data files and identify the data fields in the selected subset of data fields as being primary sensitive data fields (a.k.a. primary sensitive data elements). One or more of the primary sensitive data fields include sensitive data values, which are defined to be pre-masked data values that have a security risk exceeding a predetermined risk level. The software tool that manages data analysis matrix 106 receives indications of the data fields that are identified as primary sensitive data fields in step 206. The primary sensitive data fields are also identified in step 206 to facilitate normalization and further analysis in subsequent steps of the data masking process.

In one embodiment, a plurality of individuals analyze the data elements in the pre-obfuscation in-scope data files 102 (see FIG. 1) and the individuals include an application subject matter expert (SME).

Step 206 includes a consideration of meaningful data field names (a.k.a. data element names, element names or data names), naming standards (i.e., naming conventions), mnemonic names and data attributes. For example, step 206 identifies a primary sensitive data field that directly identifies a person, company or network.

Meaningful data names are data names that appear to uniquely and directly describe a person, customer, employee, company/corporation or location. Examples of meaningful data names include: Customer First Name, Payer Last Name, Equipment Address, and ZIP code.

Naming conventions include the utilization of items in data names such as KEY, CODE, ID, and NUMBER, which by convention, are used to assign unique values to data and most often indirectly identify a person, entity or place. In other words, data with such data names may be used independently to derive true identity on its own or paired with other data. Examples of data names that employ naming conventions include: Purchase order number, Patient ID and Contract number.

Mnemonic names include cryptic versions of the aforementioned meaningful data names and naming conventions. Examples of mnemonic names include NM, CD and NBR.

Data attributes describe the data. For example, a data attribute may describe a data element's length, or whether the data element is a character, numeric, decimal, signed or formatted. The following considerations are related to data attributes:
Short length data elements are rarely sensitive because such elements have a limited value set and therefore cannot be unique identifiers toward a person or entity.
Long and abstract data names are sometimes used generically and may be redefined outside of the data definition. The value of the data needs to be analyzed in this situation.
Sub-definition occurrences may explicitly identify a data element that further qualifies a data element to uniqueness (e.g., the exchange portion of a phone number or the house number portion of a street address).
Numbers carrying decimals are not likely to be sensitive.
Definitions implying date are not likely to be sensitive.

Varying data names (i.e., different data names that may be represented by abbreviated means or through the use of acronyms) and mixed attributes result in a large set of primary sensitive data fields selected in step 206. Such data fields may or may not be the same data element on different physical files, but in terms of data masking, these data fields are going to be handled in the same manner. Normalization in step 208 allows such data fields to be handled in the same manner during the rest of the data masking process.

In step 208, one or more members of the IT support team (e.g., a data analyst) normalize name(s) of one or more of the primary sensitive data fields identified in step 206 so that like data elements are treated consistently in the data masking process, thereby reducing the set of data elements created from varying data names and mixed attributes. In this discussion of step 208, the names of the primary sensitive data fields identified in step 206 are referred to as non-normalized data names.

Step 208 includes the following normalization process: the one or more members of the IT support team (e.g., one or more data analysts) map a non-normalized data name to a corresponding normalized data name that is included in a set of pre-defined normalized data names. The normalization process is repeated so that the non-normalized data names are mapped to the normalized data names in a many-to-one correspondence. One or more non-normalized data names may be mapped to a single normalized data name in the normalization process.

For each mapping of a non-normalized data name to a normalized data name, the software tool (e.g., spreadsheet tool) managing data analysis matrix 106 (see FIG. 1) receives a unique identifier of the normalized data name and stores the unique identifier in the data analysis matrix so that the unique identifier is associated with the non-normalized data name.

The normalization in step 208 is enabled at the data element level. The likeness of data elements is determined by the data elements' data names and also by the data definition properties of usage and length. For example, the data field names of Customer name, Salesman name and Company name are all mapped to NAME, which is a normalized data name, and by virtue of being mapped to the same normalized data name, are treated similarly in a requirements analysis included in step 212 (see below) of the data masking process. Furthermore, data elements that are assigned varying cryptic names are normalized to one normalized name. For instance, data field names of SS, SS-NUM, SOC-SEC-NO are all normalized to the normalized data name of SOCIAL SECURITY NUMBER.

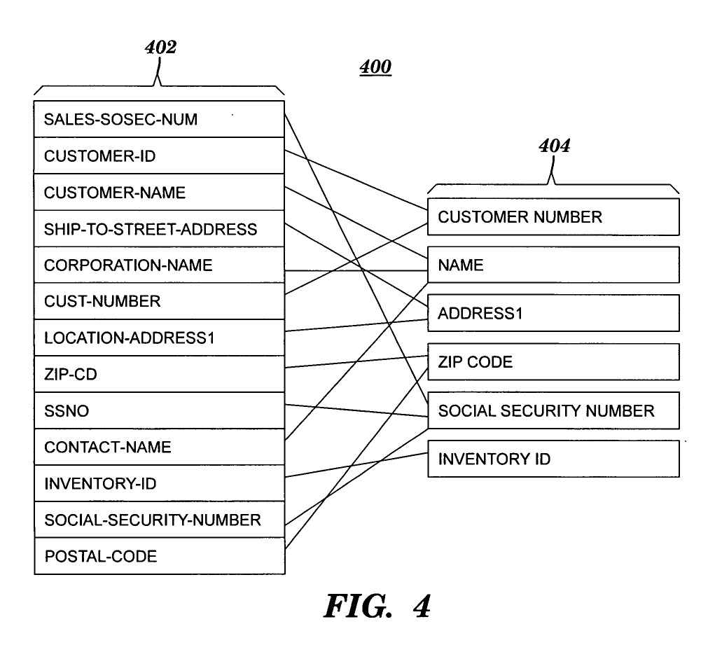

A mapping 400 in FIG. 4 illustrates a reduction of 13 non-normalized data names 402 into 6 normalized data names 404. For example, as shown in mapping 400, preliminary analysis in step 206 maps three non-normalized data names (i.e., CUSTOMER-NAME, CORPORATION-NAME and CONTACT-NAME) to a single normalized data name (i.e., NAME), thereby indicating that CUSTOMER-NAME, CORPORATION-NAME and CONTACT-NAME should be masked in a similar manner. Further analysis into the data properties and sample data values of CUSTOMER-NAME, CORPORATION-NAME and CONTACT-NAME verifies the normalization.

Returning to FIG. 2A, step 208 is a novel part of the present invention in that normalization provides a limited, finite set of obfuscation data objects (i.e., normalized names) that represent a significantly larger set that is based on varied naming conventions, mixed data lengths, alternating data usage and non-unified IT standards, so that all data elements whose data names are normalized to a single normalized name are treated consistently in the data masking process. It is step 208 that enhances the integrity of a repeatable data masking process across applications.

In step 210, one or more members of the IT support team (e.g., one or more data analysts) classify each data element of the primary sensitive data elements in a classification (i.e., category) that is included in a set of pre-defined classifications. The software tool that manages data analysis matrix 106 (see FIG. 1) receives indicators of the categories in which data elements are classified in step 210 and stores the indicators of the categories in the data analysis matrix. The data analysis matrix 106 (see FIG. 1) associates each data element of the primary sensitive data elements with the category in which the data element was classified in step 210.

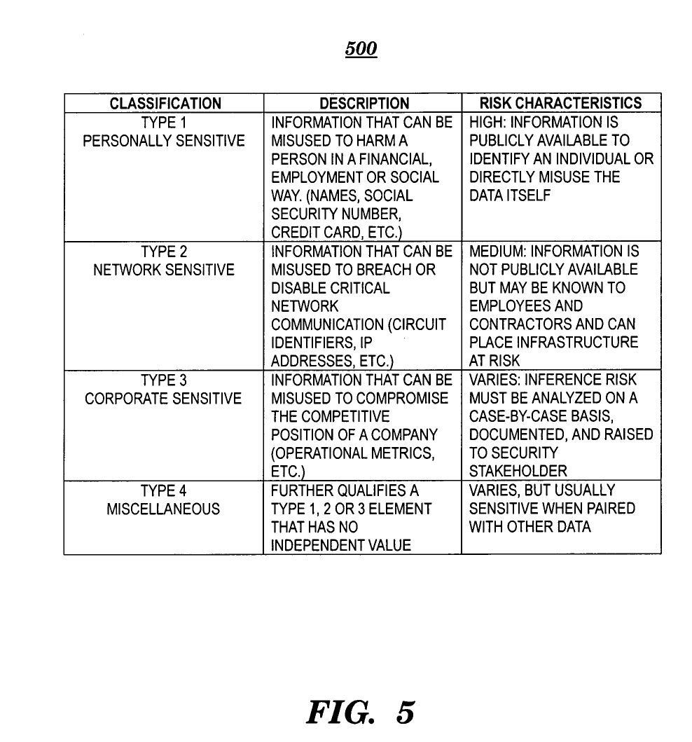

For example, each data element of the primary sensitive data elements is classified in one of four pre-defined classifications numbered 1 through 4 in table 500 of FIG. 5. The classifications in table 500 are ordered by level of sensitivity of the data element, where 1 identifies the data elements having the most sensitive data values (i.e., highest data security risk) and 4 identifies the data elements having the least sensitive data values. The data elements having the most sensitive data values are those data elements that are direct identifiers and may contain information available in the public domain. Data elements that are direct identifiers but are non-intelligent (e.g., circuit identifiers) are as sensitive as other direct identifiers, but are classified in table 500 with a sensitivity level of 2. Unique and non-intelligent keys (e.g., customer numbers) are classified at the lowest sensitivity level.

Data elements classified as having the highest data security risk (i.e., classification 1 in table 500) should receive masking over classifications 2, 3 and 4 of table 500. In some applications, and depending on who the data may be exposed to, each classification has equal risk.

Returning to FIG. 2A, step 212 includes an analysis of the data elements of the primary sensitive data elements identified in step 206. In the following discussion of step 212, a data element of a primary sensitive data elements identified in step 206 is referred to as a data element being analyzed.

In step 212, one or more members of the IT support team (e.g., one or more IT application experts and/or one or more data analysts) identify one or more rules included in business and IT rules 108 (see FIG. 1) that are applied against the value of a data element being analyzed (i.e., the one or more rules that are exercised on the data element being analyzed). Step 212 is repeated for any other data element being analyzed, where a business or IT rule is applied against the value of the data element. For example, a business rule may require data to retain a valid range of values, to be unique, to dictate the value of another data element, to have a value that is dictated by the value of another data element, etc.

The software tool that manages data analysis matrix 106 (see FIG. 1) receives the rules identified in step 212 and stores the indicators of the rules in the data analysis matrix to associate each rule with the data element on which the rule is exercised.

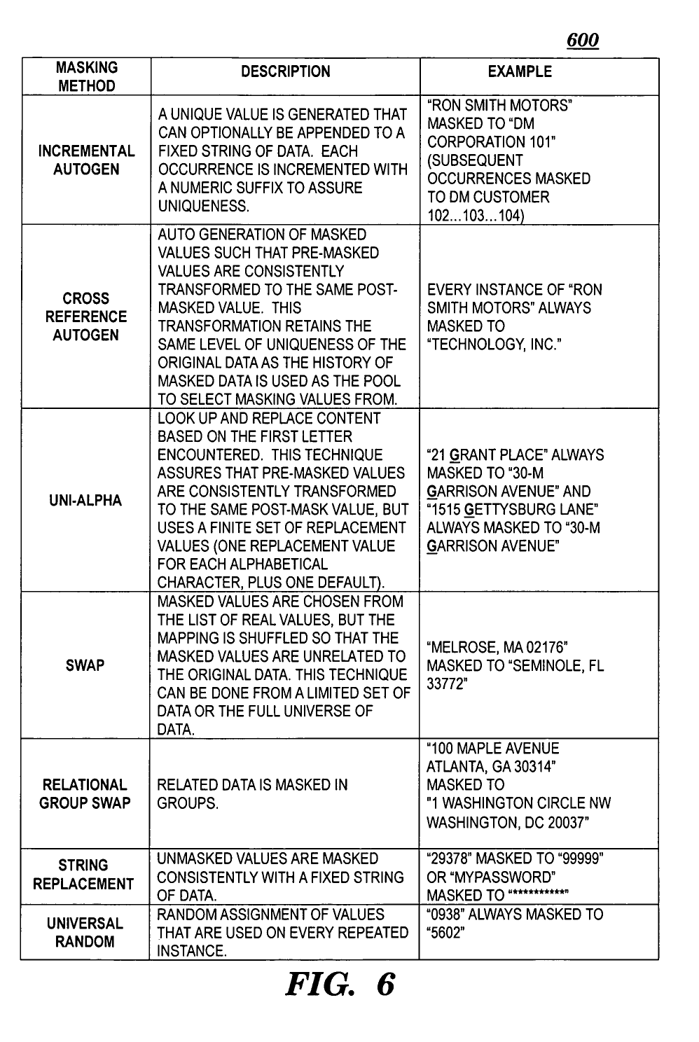

Subsequent to the aforementioned identification of the one or more business rules and/or IT rules, step 212 also includes, for each data element of the identified primary sensitive data elements, selecting an appropriate masking method from a pre-defined set of re-usable masking methods stored in a library of algorithms 114 (see FIG. 1). The pre-defined set of masking methods is accessed from data masking tool 110 (see FIG. 1) (e.g., IBM® WebSphere® DataStage). In one embodiment, the pre-defined set of masking methods includes the masking methods listed and described in table 600 of FIG. 6.

Returning to step 212 of FIG. 2, the appropriateness of the selected masking method is based on the business rule(s) and/or IT rule(s) identified as being applied to the data element being analyzed. For example, a first masking method in the pre-defined set of masking methods assures uniqueness, a second masking method assures equal distribution of data, a third masking method enforces referential integrity, etc.

The selection of the masking method in step 212 requires the following considerations:
Does the data element need to retain intelligent meaning?
Will the value of the post-masked data drive logic differently than pre-masked data?
Is the data element part of a larger group of related data that must be masked together?
What are the relationships of the data elements being masked? Do the values of one masked data field dictate the value set of another masked data field?
Must the post-masked data be within the universe of values contained in the pre-masked data for reasons of test certification?
Does the post-masked data need to include consistent values in every physical occurrence, across files and/or across applications?

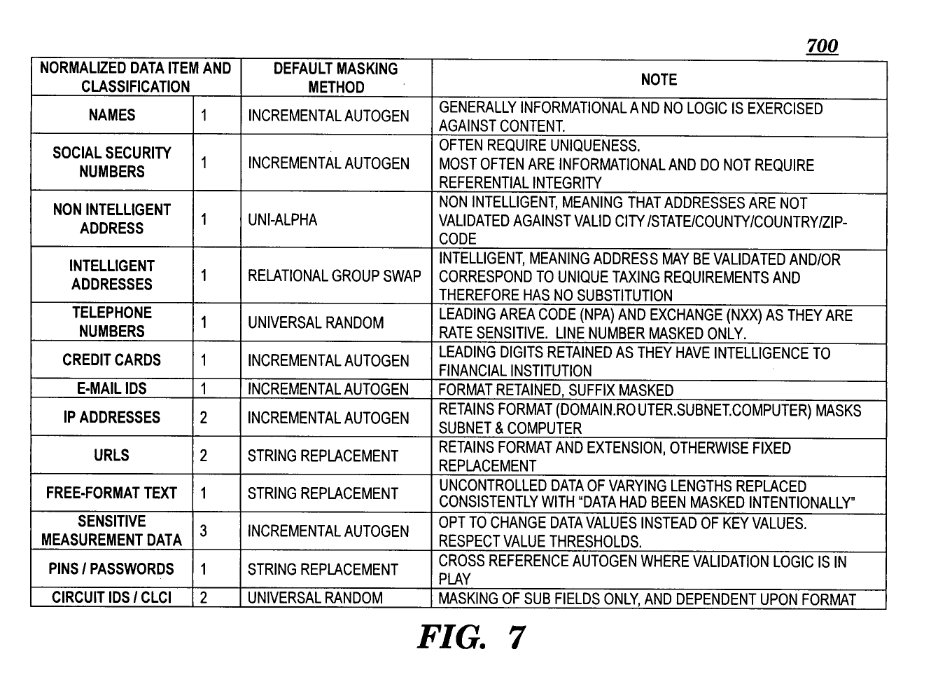

If no business or IT rule is exercised on a data element being analyzed, the default masking method shown in table 700 of FIG. 7 is selected for the data element in step 212.

A selection of a default masking method is overridden if a business or IT rule applies to a data element, such as referential integrity requirements or a requirement for valid value sets. In such cases, the default masking method is changed to another masking method included in the set of pre-defined masking methods and may require a more intelligent masking technique (e.g., a lookup table).

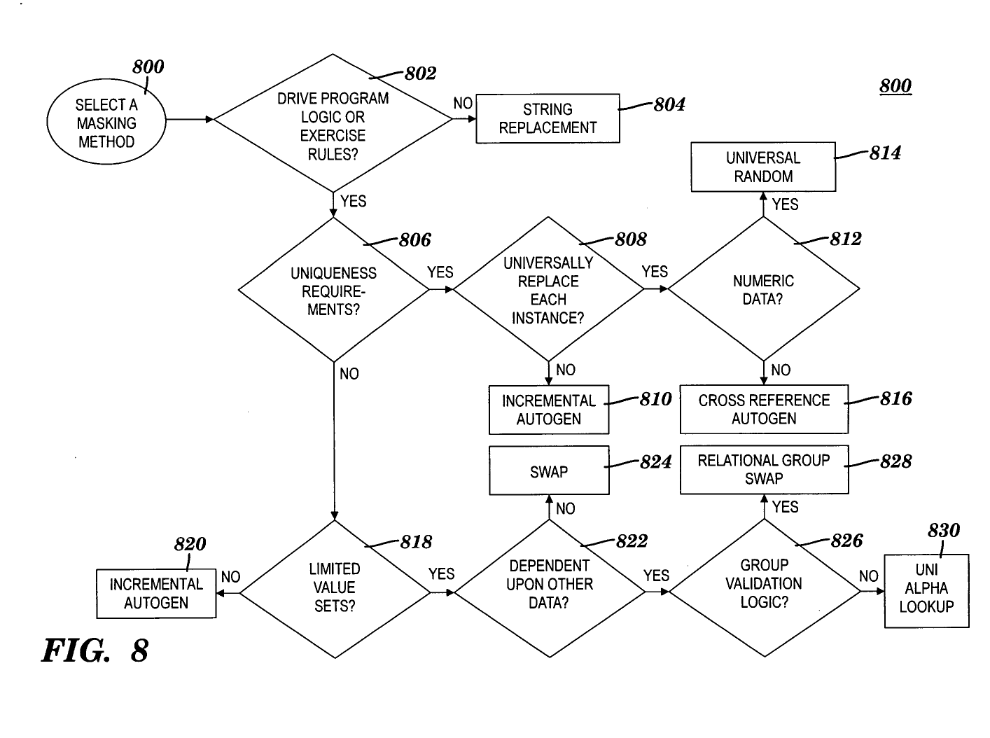

In one embodiment, the selection of a masking method in step 212 is provided by the detailed masking method selection process of FIG. 8, which is based on a business or IT rule that is exercised on the data element. The masking method selection process of FIG. 8 results in a selection of a masking method that is included in table 600 of FIG. 6. In the discussion below relative to FIG. 8, “rule” refers to a rule that is included in business and IT rules 108 (see FIG. 1) and “data element” refers to a data element being analyzed in step 212 (see FIG. 2A). The steps of the process of FIG. 8 may be performed automatically by software (e.g., software included in data masking tool 110 of FIG. 1) or manually by one or more members of the IT support team.

The masking method selection process begins at step 800. If inquiry step 802 determines that the data element does not have an intelligent meaning (i.e., the value of the data element does not drive program logic in the application and does not exercise rules), then the string replacement masking method is selected in step 804 as the masking method to be applied to the data element and the process of FIG. 8 ends.

If inquiry step 802 determines that the data element has an intelligent meaning, then the masking method selection process continues with inquiry step 806. If inquiry step 806 determines that a rule requires that the value of the data element remain unique within its physical file entity (i.e., uniqueness requirements are identified), then the process of FIG. 8 continues with inquiry step 808.

If inquiry step 808 determines that no rule requires referential integrity and no rule requires that each instance of the pre-masked value of the data element must be universally replaced with a corresponding post-masked value (i.e., No branch of step 808), then the incremental autogen masking method is selected in step 810 as the masking method to be applied to the data element and the process of FIG. 8 ends.

If inquiry step 808 determines that a rule requires referential integrity or a rule requires that each instance of the pre-masked value of the data element must be universally replaced with a corresponding post-masked value (i.e., Yes branch of step 808), then the process of FIG. 8 continues with inquiry step 812.

A rule requiring referential integrity indicates that the value of the data element is used as a key to reference data elsewhere and the referenced data must be considered to ensure consistent masked values.

A rule (a.k.a. universal replacement rule) requiring that each instance of the pre-masked value must be universally replaced with a corresponding post-masked value means that each and every occurrence of a pre-masked value must be replaced consistently with a post-masked value. For example, a universal replacement rule may require that each and every occurrence of “SMITH” be replaced consistently with “MILLER”.

If inquiry step 812 determines that a rule requires that the data element includes only numeric data, then the universal random masking method is selected in step 814 as the masking method to be applied to the data element and the process of FIG. 8 ends; otherwise step 812 determines that the data element may include non-numeric data, the cross reference autogen masking method is selected in step 816 and the process of FIG. 8 ends.

Returning to inquiry step 806, if uniqueness requirements are not identified (i.e., No branch of step 806), then the process of FIG. 8 continues with inquiry step 818. If inquiry step 818 determines that no rule requires that values of the data element be limited to valid ranges or limited to valid value sets (i.e., No branch of step 818), then the incremental autogen masking method is selected in step 820 as the masking method to be applied to the data element and the process of FIG. 8 ends.

If inquiry step 818 determines that a rule requires that values of the data element are limited to valid ranges or valid value sets (i.e., Yes branch of step 818), then the process of FIG. 8 continues with inquiry step 822.

If inquiry step 822 determines that no dependency rule requires that the presence of the data element is dependent on a condition, then the swap masking method is selected in step 824 as the masking method to be applied to the data element and the process of FIG. 8 ends.

If inquiry step 822 determines that a dependency rule requires that the presence of the data element is dependent on a condition, then the process of FIG. 8 continues with inquiry step 826.

If inquiry step 826 determines that a group validation logic rule requires that the data element is validated by the presence or value of another data element, then the relational group swap masking method is selected in step 828 as the masking method to be applied to the data element and the process of FIG. 8 ends; otherwise the uni alpha masking method is selected in step 830 as the masking method to be applied to the data element and the process of FIG. 8 ends.

The rules considered in the inquiry steps in the process of FIG. 8 are retrieved from data analysis matrix 106 (see FIG. 1). Automatically applying consistent and repeatable rule analysis across applications is facilitated by the inclusion of rules in data analysis matrix 106 (see FIG. 1).

Returning to the discussion of FIG. 2A, steps 202, 204, 206, 208, 210 and 212 complete data analysis matrix 106 (see FIG. 1). Data analysis matrix 106 (see FIG. 1) includes documented requirements for the data masking process and is used in an automated step (see step 218) to create data obfuscation template jobs.

In step 214, application specialists, such as testing resources and development SMEs, participate in a review forum to validate a masking approach that is to use the masking method selected in step 212. The application specialists define requirements, test and support production. Application experts employ their knowledge of data usage and relationships to identify instances where candidates for masking may be hidden or disguised. Legal representatives of the client who owns the application also participate in the forum to verify that the masking approach does not expose the client to liability.

The application scope diagram resulting from step 202 and data analysis matrix 106 (see FIG. 1) are used in step 214 by the participants of the review forum to come to an agreement as to the scope and methodology of the data masking. The upcoming data profiling step (see step 216 described below), however, may introduce new discoveries that require input from the application experts.

Output of the review forum conducted in step 214 is either a direction to proceed with step 216 (see FIG. 2B) of the data masking process, or require additional information to incorporate into data analysis matrix 106 (see FIG. 1) and into other masking method documentation stored by the software tool that manages the data analysis matrix. As such, the process of step 214 may be iterative.

The data masking process continues in FIG. 2B. At this point in the data masking process, paper analysis and subject matter experts' review is complete. The physical files associated with each data definition now need to be profiled. In step 216 of FIG. 2B, data analyzer tool 104 (see FIG. 1) profiles the actual values of the primary sensitive data fields identified in step 206 (see FIG. 2A). The data profiling performed by data analyzer tool 104 (see FIG. 1) in step 216 includes reviewing and thoroughly analyzing the actual data values to identify patterns within the data being analyzed and allow replacement rules to fall within the identified patterns. In addition, the profiling performed by data analyzer tool 104 (see FIG. 1) includes detecting invalid data (i.e., data that does not follow the rules which the obfuscated replacement data must follow). In response to detecting invalid data, the obfuscated data corrects error conditions or exception logic bypasses such data. As one example, the profiling in step 216 determines that data that is defined is actually not present. As another example, the profiling in step 216 may reveal that Shipping-Address and Ship-to-Address mean two entirely different things to independent programs.

Other factors that are considered in the data profiling of step 216 include:
Business rule violations
Inconsistent formats caused by an unknown change to definitions
Data cleanliness
Missing data
Statistical distribution of data
Data interdependencies (e.g., compatibility of a country and currency exchange)

In one embodiment IBM® WebSphere® Information Analyzer is the data analyzer tool used in step 216 to analyze patterns in the actual data and to identify exceptions in a report, where the exceptions are based on the factors described above. The identified exceptions are then used to refine the masking approach.

In step 218, data masking tool 110 (see FIG. 1) leverages the reusable libraries for the selected masking method. In step 218, the development of the software for the selected masking method begins with creating metadata 112 (see FIG. 1) for the data definitions collected in step 204 (see FIG. 2A) and carrying data from input to output with the exception of the data that needs to be masked. Data values that require masking are transformed in a subsequent step of the data masking process by an invocation of a masking algorithm that is included in algorithms 114 (see FIG. 1) and that corresponds to the masking method selected in step 212 (see FIG. 2A). Further, the software developed in step 218 utilizes reusable reporting jobs that record the action taken on the data, any exceptions generated during the data masking process, and operational statistics that capture file information, record counts, etc. The software developed in step 218 is also referred to herein as a data masking job or a data obfuscation template job.

As data masking efforts using the present invention expand beyond an initial set of applications, there is a substantial likelihood that the same data will have the same general masking requirements. However, each application may require further customization, such as additional formatting, differing data lengths, business logic or rules for referential integrity.

In one example in which data masking tool 110 (see FIG. 1) is implemented by IBM® WebSphere® DataStage, an ETL (Extract Transform Load) tool used to transform pre-masked data to post-masked data. IBM® WebSphere® DataStage is a GUI based tool that generates the code for the data masking utilities that are configured in step 218. The code is generated by IBM® WebSphere® DataStage based on imports of data definitions and applied logic to transform the data. IBM® Web Sphere® DataStage invokes a masking algorithm through batch or real time transactions and supports any of a plurality of database types on a variety of platforms (e.g., mainframe and/or midrange platforms).

Further, IBM® WebSphere® DataStage reuses data masking algorithms 114 (see FIG. 1) that support common business rules 108 (see FIG. 1) that align with the normalized data elements so there is assurance that the same data is transformed consistently irrespective of the physical file in which the data resides and irrespective of the technical platform of which the data is a part. Still further, IBM® WebSphere® DataStage keeps a repository of reusable components from data definitions and reusable masking algorithms that facilitates repeatable and consistent software development.

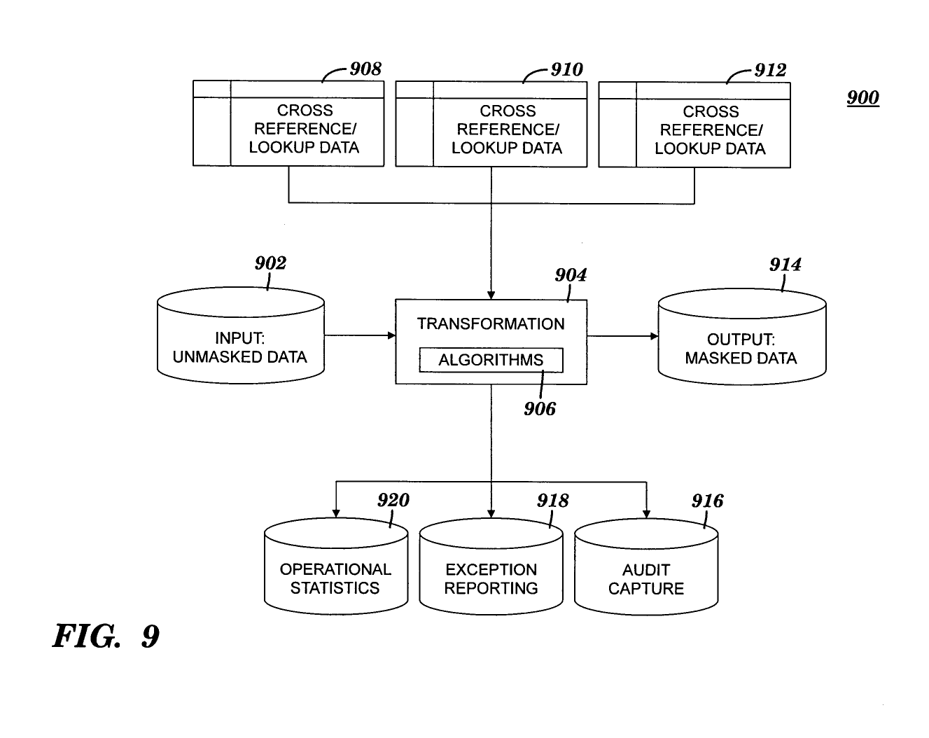

The basic construct of a data masking job is illustrated in system 900 in FIG. 9. Input of unmasked data 902 (i.e., pre-masked data) is received by a transformation tool 904, which employs data masking algorithms 906. Unmasked data 902 may be one of many database technologies and may be co-resident with IBM® WebSphere® DataStage or available through an open database connection thorough a network. The transformation tool 904 is the product of IBM® WebSphere® DataStage. Transformation tool 904 reads input 902, applies the masking algorithms 906. One or more of the applied masking algorithms 906 utilize cross-reference and/or lookup data 908, 910, 912. The transformation tool generates output of masked data 914. Output 914 may associated with a database technology or format that may or may not be identical to input 902. Output 914 may co-reside with IBM® WebSphere® DataStage or be written across the network. The output 914 can be the same physical database as the input 902. For each data masking job, transformation tool 904 also generates an audit capture report stored in an audit capture repository 916, an exception report stored in an exception reporting repository 918 and an operational statistics report stored in an operational statistics repository 920. The audit capture report serves as an audit to record the action taken on the data. The exception report includes exceptions generated by the data masking process. The operational statistics report includes operational statistics that capture file information, record counts, etc.

Input 902, transformation tool 904, output 914, and repository 916 correspond to pre-obfuscation in-scope data files 102 (see FIG. 1), data masking tool 110 (see FIG. 1), and audit capture repository 116 (see FIG. 1), respectively. Further, repositories 918 and 920 are included in validation control data & report repository 118 (see FIG. 1).

Returning to the discussion of FIG. 2B, in step 220, one or more members of the IT support team apply input considerations to design and operations. Step 220 is a customization step in which special considerations need to be applied on an application or data file basis. For example, the input considerations applied in step 220 include physical file properties, organization, job sequencing, etc.

The following application-level considerations that are taken into account in step 220 may affect the performance of a data masking job, when data masking jobs should be scheduled and where the data masking jobs should be delivered:
Expected data volumes/capacity that may introduce run options, such as parallel processing
Window of time available to perform masking
Environment/platform to which masking will occur
Application technology database management system
Development or data naming standards in use, or known violations of a standard
Organization roles and responsibilities
External processes, applications and/or work centers affected by masking activities

In step 222, one or more members of the IT support team (e.g., one or more data masking developers/specialists and/or one or more data masking solution architects) develop validation procedures relative to pre-masked data and post-masked data. Pre-masked input from pre-obfuscation in-scope data files 102 (see FIG. 1) must be validated toward the assumptions driving the design. Validation requirements for post-masked output in post-obfuscation in-scope data files 120 (see FIG. 1) include a mirroring of the input properties or value sets, but also may include an application of further validations or rules outlined in requirements.

Relative to each masked data element, data masking tool 110 (see FIG. 1) captures and stores the following information as a validation report in validation control data & report repository 118 (see FIG. 1):
File name
Data definition used
Data element name
Pre-masked value
Post-masked value

The above-referenced information in the aforementioned validation report is used to validate against the physical data and the defined requirements.

As each data masking job is constructed in steps 218, 220 and 222, the data masking job is placed in a repository of data masking tool 110. Once all data masking jobs are developed and tested to perform data obfuscation on all files within the scope of the application, the data masking jobs are choreographed in a job sequence to run in an automated manner that considers any dependencies between the data masking jobs. The job sequence is executed in step 224 to access the location of unmasked data in pre-obfuscation in-scope data files 102 (see FIG. 1), execute the data transforms (i.e., masking methods) to obfuscate the data, and place the masked data in a specific location in post-obfuscation in-scope data files 120 (see FIG. 1). The placement of the masked data may replace the unmasked data or the masked data may be an entirely new set of data that can be introduced at a later time. Once the execution of the job sequence is completed in step 224, data masking tool 110 (see FIG. 1) provides the tools (i.e., reports stored in repositories 916, 918 and 920 of FIG. 9) to allow one or members of the IT support team (e.g., a data masking operator) to manually verify the integrity of operational behavior of the data masking jobs. For example, the data masking operator verifies the integrity of operational behavior by ensuring that (1) the proper files were input to the data masking process, (2) the masking methods completed successfully for all the files, and (3) exceptions were not fatal.

Data masking tool 110 (see FIG. 1) allows pre-sequencing to execute masking methods in a specific order to retain the referential integrity of data and to execute in the most efficient manner, thereby avoiding the time constraints of taking data off-line, executing masking processes, validating the masked data and introducing the data back into the data stream.

In step 226, a regression test 124 (see FIG. 1) of the application with masked data in post-obfuscation in-scope data files 120 (see FIG. 1) validates the functional behavior of the application and validates full test coverage. The output masked data is returned back to the system test environment, and needs to be integrated back into a full test cycle, which is defined by the full scope of the application identified in step 202 (see FIG. 2A). This need for the masked data to be integrated back into a full test cycle is because simple and positive validation of masked data to requirements does not imply that the application can process that data successfully. The application's functional behavior must be the same when processing against obfuscated data.

Common discoveries in step 226 include unexpected data content that may require re-design. Some errors will surface in the form of a critical operational failure; other errors may be revealed as non-critical defects in the output result. Whichever the case, the errors are time-consuming to debug. The validation of the masking approach in step 214 (see FIG. 2A) and the data profiling in step 216 reduces the risk of poor results in step 226.

Once the application is fully executed to completion, the next step in validating application behavior in step 226 is to compare output files from the last successful system test run. This comparison should identify differences in data values, but the differences should be explainable and traceable to the data that was masked.

In step 228, after a successful completion and validation of the data masking, members of the IT support team (e.g., the project manager, data masking solution architect, data masking developers and data masking operator) refer to the key work products of the data masking process to conduct a post-masking retrospective. The key work products include the application scope diagram, data analysis matrix 106 (see FIG. 1), masking method documentation and documented decisions made throughout the previous steps of the data masking process.

The retrospective conducted in step 228 includes collecting the following information to calibrate future efforts (e.g., to modify business and IT rules 108 of FIG. 1).
The analysis results (e.g., what was masked and why).
Execution performance metrics that can used to calibrate expectations for future applications.
Development effort sizing metrics (e.g., how many interfaces, how many data fields, how many masking methods, how many resources). This data is used to calibrate future efforts.
Proposed and actual implementation schedule.
Lessons learned.
Detailed requirements and stakeholder approvals.
Archival of error logs and remediation of unresolved errors, if any.
Audit trail of pre-masked data and post-masked data (e.g., which physical files, the pre-masked and post-masked values, date and time, and production release).
Considerations for future enhancements of the application or masking methods.

The data masking process ends at step 230.

### EXAMPLE

A fictitious case application is described in this section to illustrate how each step of the data masking process of FIGS. 2A-B is executed. The case application is called ENTERPRISE BILLING and is also simply referred to herein as the billing application. The billing application is used in a telecommunications industry and is a simplified model. The function of the billing application is to periodically provide billing for a set of customers that are kept in a database maintained by the ENTERPRISE MAINTENANCE application, which is external to the ENTERPRISE BILLING application. Transactions queued up for the billing application are supplied by the ENTERPRISE QUEUE application. These events are priced via information kept on product reference data. Outputs of the billing application are Billing Media, which is sent to the customer, general ledger data which is sent to an external application called ENTERPRISE GL, and billing detail for the external ENTERPRISE CUSTOMER SUPPORT application. ENTERPRISE BILLING is a batch process and there are no on-line users providing or accessing real-time data. Therefore all data referenced in this section is in a static form.

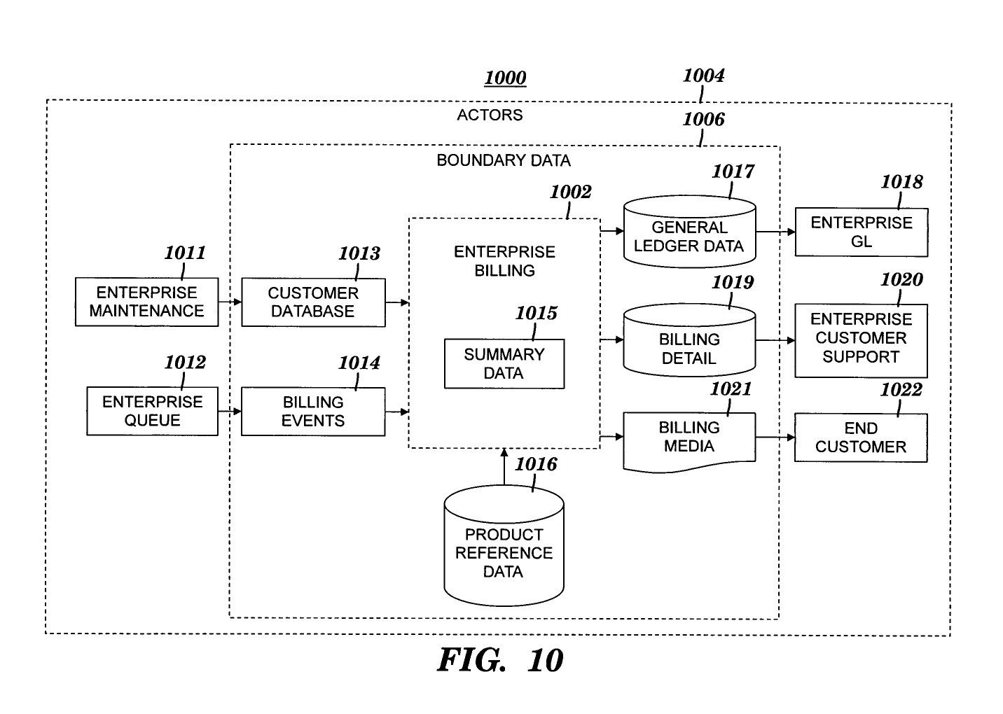

An example of an application scope diagram that is generated by step 202 (see FIG. 2A) and that includes the ENTERPRISE BILLING application is application scope diagram 1000 in FIG. 10. Diagram 1000 includes ENTERPRISE BILLING application 1002, as well as an actors layer 1004 and a boundary data layer 1006 around billing application 1002. Two external feeding applications, ENTERPRISE MAINTENANCE 1011 and ENTERPRISE QUEUE 1012, supply CUSTOMER DATABASE 1013 and BILLING EVENTS 1014, respectively, to ENTERPRISE BILLING application 1002. Billing application 1002 uses PRODUCT REFERENCE DATA 1016 to generate output interfaces GENERAL LEDGER DATA 1017 for the ENTERPRISE GL application 1018 and BILLING DETAIL 1019 for the ENTERPRISE CUSTOMER SUPPORT application 1020. Finally, billing application 1002 sends BILLING MEDIA 1021 to end customer 1022.

In the context shown by diagram 1000, the data entities that are in the scope of data obfuscation analysis identified in step 202 (see FIG. 2A) are the input data: CUSTOMER DATABASE 1013, BILLING EVENTS 1014 and PRODUCT REFERENCE DATA 1016.

Data entities that are not in the scope of data obfuscation analysis are the SUMMARY DATA 1015 kept within ENTERPRISE BILLING application 1002 and the output data: GENERAL LEDGER DATA 1017, BILLING DETAIL 1019 and BILLING MEDIA 1021. It is a certainty that the aforementioned output data is all derived directly or indirectly from the input data (i.e., CUSTOMER DATABASE 1013, BILLING EVENTS 1014 and PRODUCT REFERENCE DATA 1016). Therefore, if the input data is obfuscated, then the resulting desensitized data will carry to the output data.

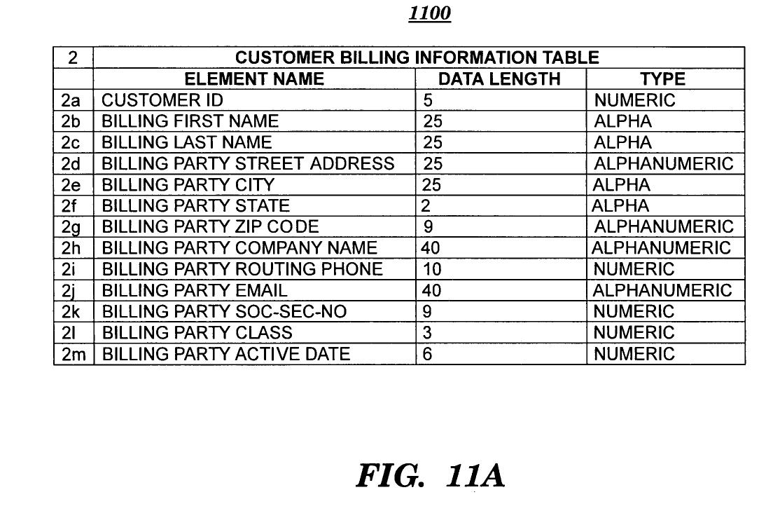

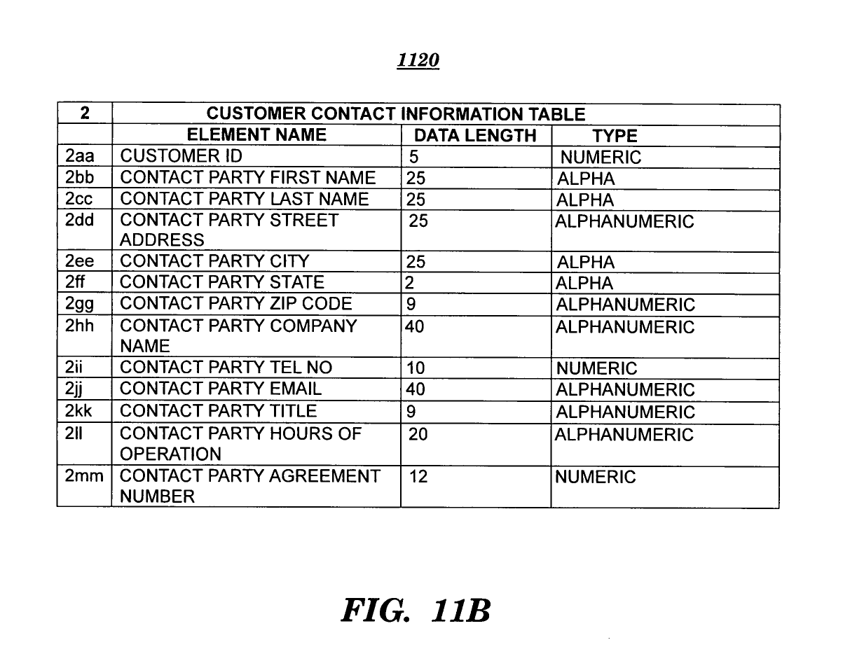

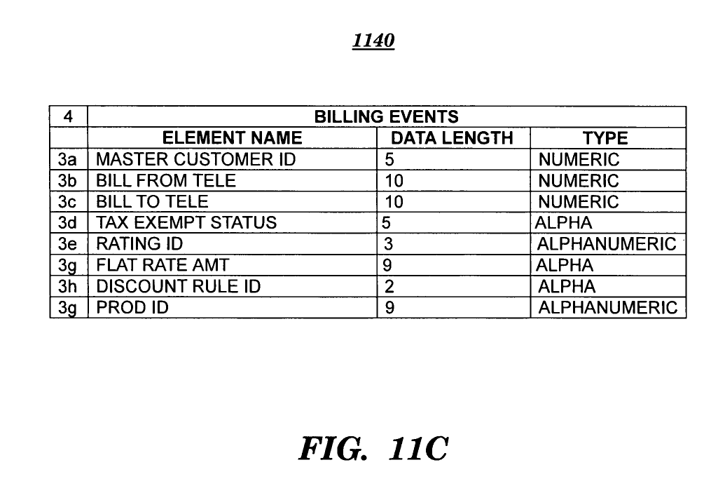

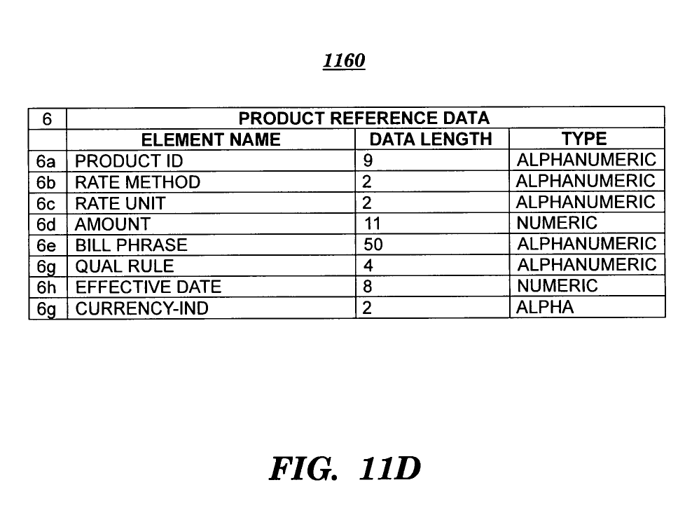

Examples of the data definitions collected in step 204 (see FIG. 2A) are included in the COBOL Data Definition illustrated in a Customer Billing Information table 1100 in FIG. 11A, a Customer Contact Information table 1120 in FIG. 11B, a Billing Events table 1140 in FIG. 11C and a Product Reference Data table 1160 in FIG. 11D.

Examples of information received in step 204 by the software tool that manages data analysis matrix 106 (see FIG. 1) may include entries in seven of the columns in the sample data analysis matrix excerpt depicted in FIGS. 12A-12C. Examples of information received in step 204 include entries in the following columns shown in a first portion 1200 (see FIG. 12A) of the sample data analysis matrix excerpt: Business Domain, Application, Database, Table or Interface Name, Element Name, Attribute and Length. Descriptions of the columns in the sample data analysis matrix excerpt of FIGS. 12A-12C are included in the section below entitled Data Analysis Matrix.

Examples of the indications received in step 206 by the software tool that manages data analysis matrix 106 (see FIG. 1) are shown in the column entitled “Does this Data Contain Sensitive Data?” in the first portion 1200 (see FIG. 12A) of the sample data analysis matrix excerpt. The Yes and No indications in the aforementioned column indicate the data fields that are suspected to contain sensitive data.

Examples of the indicators of the normalized data names to which non-normalized names were mapped in step 208 (see FIG. 2A) are shown in the column labeled Normalized Name in the second portion 1230 (see FIG. 12B) of the sample data analysis matrix excerpt. For data elements that are not included in the primary sensitive data elements identified in step 206 (see FIG. 2A), a specific indicator (e.g., N/A) in the Normalized Name column indicates that no normalization is required.

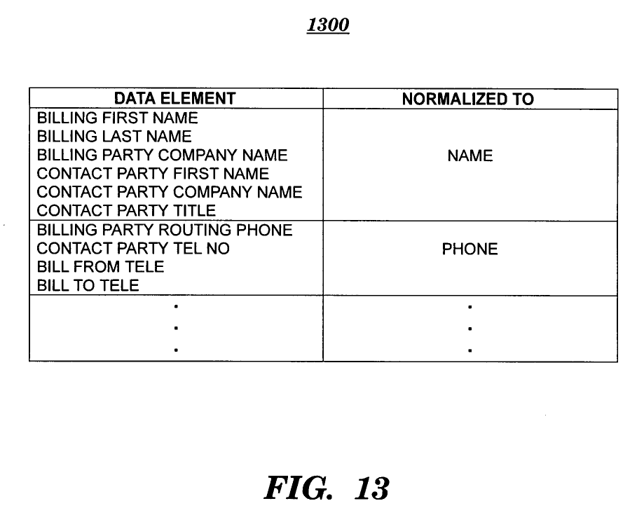

A sample excerpt of a mapping of data elements having non-normalized data names to normalized data names is shown in table 1300 of FIG. 13. The data elements in table 1300 include data element names included in table 1100 (see FIG. 11A), table 1120 (see FIG. 11B) and table 1140 (see FIG. 11C). The data elements having non-normalized data names (e.g., BILLING FIRST NAME, BILLING PARTY ROUTING PHONE, etc.) are mapped to the normalized data names (e.g., Name and Phone) as a result of normalization step 208 (see FIG. 2A).

Examples of the indicators of the categories in which data elements are classified in step 210 (see FIG. 2A) are shown in the column labeled Classification in the second portion 1230 (see FIG. 12B) of the sample data analysis matrix excerpt. In the billing application example of this section, all of the data elements are classified as Type 1—Personally Sensitive, with the exception of address-related data elements that indicate a city or a state. These address-related data elements indicating a city or state are classified as Type 4. A city or state is not granular enough to be classified as Personally Sensitive. A fully qualified 9-digit zip code (e.g., Billing Party Zip Code, which is not shown in FIG. 12A) is specific enough for the Type 1 classification because the 4-digit suffix of the 9-digit zip code often refers to a specific street address. The aforementioned sample classifications illustrate that rules must be extracted from business intelligence and incorporated into the analysis in the data masking process.

Examples of indicators (i.e., Y or N) of rules identified in step 212 (see FIG. 2A) are included in the following columns of the second portion 1230 (see FIG. 12B) of the sample data analysis matrix excerpt: Universal Ind, Cross Field Validation and Dependencies. Additional examples of indicators of rules to consider in step 212 (see FIG. 2A) are included in the following columns of the third portion 1260 (see FIG. 12C) of the sample data analysis matrix excerpt: Uniqueness Requirements, Referential Integrity, Limited Value Sets and Necessity of Maintaining Intelligence. The Y indicator of a rule indicates that the analysis in step 212 (see FIG. 2A) identifies the rule as being exercised on the data element associated with the indicator of the rule by the data analysis matrix. The N indicator of a rule indicates that the analysis in step 212 (see FIG. 2A) determines that the rule is not exercised on the data element associated with the indicator of the rule by the data analysis matrix.

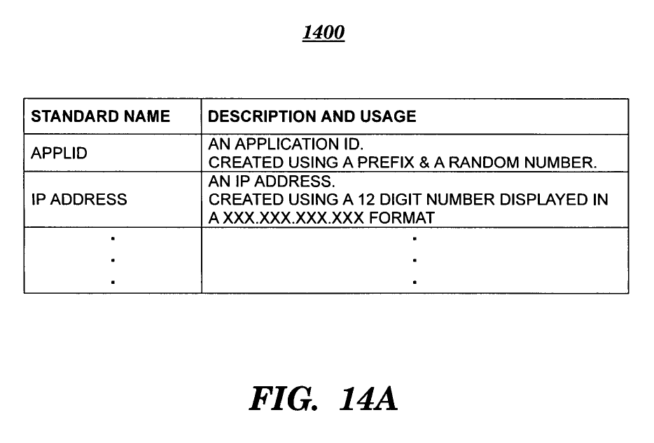

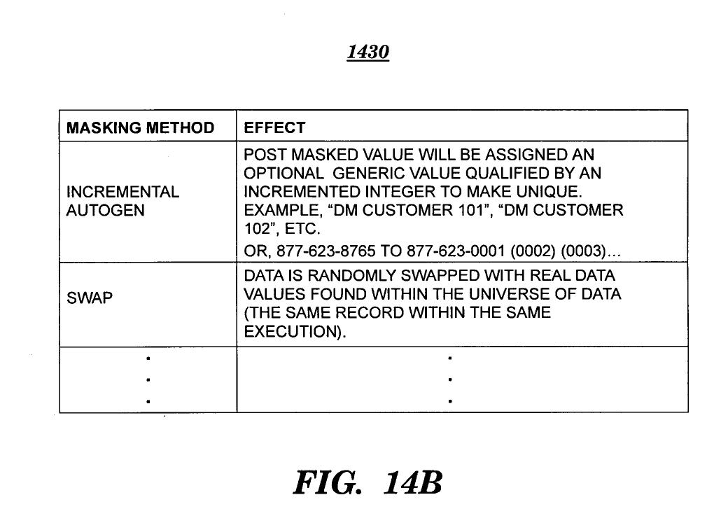

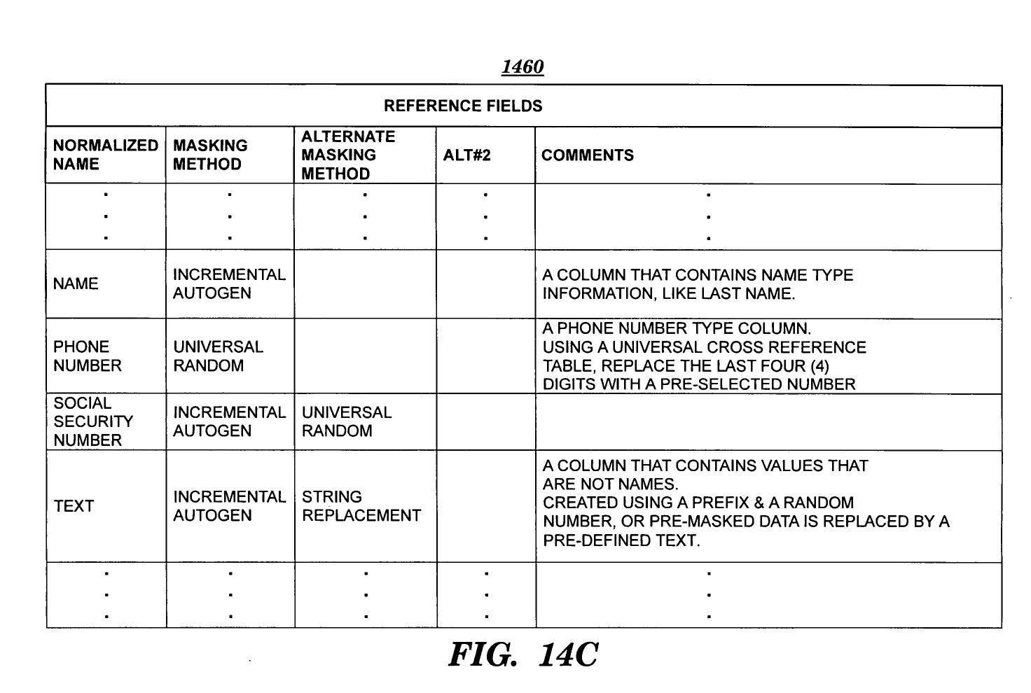

Examples of the application scope diagram, data analysis matrix, and masking method documentation presented to the application SMEs in step 214 are depicted, respectively, in diagram 1000 (see FIG. 10), data analysis matrix excerpt (see FIGS. 12A-12C) and an excerpt of masking method documentation (MMD) (see FIGS. 14A-14C). The MMD documents the expected result of the obfuscated data. The excerpt of the MMD is illustrated in a first portion 1400 (see FIG. 14A) of the MMD, a second portion 1430 (see FIG. 14B) of the MMD and a third portion 1460 (see FIG. 14C) of the MMD. The first portion 1400 (see FIG. 14A) of the MMD includes standard data names along with a description and usage of the associated data element. The second portion 1430 (see FIG. 14B) of the MMD includes the pre-defined masking methods and their effects. The third portion 1460 (see FIG. 14C) of the MMD includes normalized names of data fields, along with the normalized names' associated masking method, alternate masking method and comments regarding the data in the data fields.

IBM® WebSphere® Information Analyzer is an example of the data analyzer tool 104 (see FIG. 1) that is used in the data profiling step 216 (see FIG. 2B). IBM® WebSphere® Information Analyzer displays data patterns and exception results. For example, data is displayed that was defined/classified according to a set of rules, but that is presented in violation of that set of rules. Further, IBM® WebSphere® Information Analyzer displays the percentage of data coverage and the absence of valid data. Such results from step 216 (see FIG. 2B) can be built into the data obfuscation customization, or even eliminate the need to obfuscate data that is invalid or not present.

IBM® WebSphere® Information Analyzer also displays varying formats and values of data. For example, the data analyzer tool may display multiple formats for an e-mail ID that must be considered in determining the obfuscated output result. The data analyzer tool may display that an e-mail ID contains information other than an e-mail identifier (e.g., contains a fax number) and that exception logic is needed to handle such non-e-mail ID information.

For the billing application example of this section, four physical data obfuscation jobs (i.e., independent software units) are developed in step 218 (see FIG. 2B). Each of the four data obfuscation jobs masks data in a corresponding table in the list presented below:
Customer Billing Information Table (see table 1100 of FIG. 11A)
Customer Contact Information Table (see table 1120 of FIG. 11B)
Billing Events (see table 1140 of FIG. 11C)
Product Reference Data (see table 1160 of FIG. 11D)

Each of the four data obfuscation jobs creates a replacement set of files with obfuscated data and generates the reporting needed to confirm the obfuscation results. In the example of this section IBM® WebSphere® DataStage is used to create the four data obfuscation jobs.

Examples of input considerations applied in step 220 (see FIG. 2B) are included in the column labeled Additional Business Rule in the third portion 1260 (see FIG. 12C) of the sample data analysis matrix excerpt.

A validation procedure is developed in step 222 (see FIG. 2B) to compare the input of sensitive data to the output of desensitized data for the following files:
Customer Billing Information Table (see table 1100 of FIG. 11A)
Customer Contact Information Table (see table 1120 of FIG. 11B)
Billing Events (see table 1140 of FIG. 11C)
Product Reference Data (see table 1160 of FIG. 11D)

Ensuring that content and record counts are the same is part of the validation procedure. The only deltas should be the data elements flagged with a Y (i.e., “Yes” indicator) in the column labeled Require Masking in the second portion 1230 (see FIG. 12B) of the data analysis matrix excerpt.

The reports created out of each data obfuscation job are also included in the validation procedure developed in step 222 (see FIG. 2B). The reports included in step 222 reconcile with the data and prove out the operational integrity of the run.

Along with the validation procedure, scripts are developed for automation in the validation phase.

The following in-scope files for the ENTERPRISE BILLING application include sensitive data that needs obfuscation:
Customer Billing Information Table (see table 1100 of FIG. 11A)
Customer Contact Information Table (see table 1120 of FIG. 11B)
Billing Events (see table 1140 of FIG. 11C)
Product Reference Data (see table 1160 of FIG. 11D)

IBM® WebSphere® DataStage parameters are set to point to the location of the above-listed files and execute in step 224 (see FIG. 2B) the previously developed data obfuscation jobs. The execution creates new files that have desensitized output data and that are ready to be verified against the validation procedure developed in step 222 (see FIG. 2B). In response to completing the validation of the new files, the new files are made available to the ENTERPRISE BILLING application.

### Data Analysis Matrix

This section includes descriptions of the columns of the sample data analysis matrix excerpt depicted in FIGS. 12A-12C.

Column A: Business Domain. Indicates what Enterprise function is fulfilled by the application (e.g., Order Management, Billing, Credit & Collections, etc.) Column B: Application. The application name as referenced in the IT organization.

Column C: Database (if appl). If applicable, the name of the database that includes the data element.

Column D: Table or Interface Name. The name of the physical entity of data. This entry can be a table in a database or a sequential file, such as an interface.

Column E: Element Name. The name of the data element (e.g., as specified by a database administrator or programs that reference the data element) Column F: Does this Data Contain. A Yes indicator if the data element contains an item in the following list of sensitive items; otherwise No is indicated:
CUSTOMER OR COMPANY NAME
STREET ADDRESS
SOCIAL SECURITY NUMBER
CREDIT CARD NUMBER
TELEPHONE NUMBER
CALLING CARD NUMBER
PIN OR PASSWORD
E-MAIL ID
URL
NETWORK CIRCUIT ID
NETWORK IP ADDRESS
FREE FORMAT TEXT THAT MAY REFERENCE DATA LISTED ABOVE

As the data masking process is implemented in additional business domains, the list of sensitive items relative to column F may be expanded.

Column G: Attribute. Attribute or properties of the data element (e.g., nvarchar, varchar, floaty, text, integer, etc.)

Column H: Length. The length of data in characters/bytes. If Data is described by mainframe COBOL copybook, please specify picture clause and usage

Column I: Null Ind. An identification of what was used to specify a nullable field (e.g., spaces)

Column J: Normalized Name. Assign a normalized data name to the data element only if the data element is deemed sensitive. Sensitive means that the data element contains an intelligent value that directly and specifically identifies an individual or customer (e.g., business). Non-intelligent keys that are not available in the public domain are not sensitive. Select from pre-defined normalized data names such as: NAME, STREET ADDRESS, SOCIAL SECURITY NUMBER, IP ADDRESS, E-MAIL ID, PIN/PASSWORD, SENSITIVE FREEFORM TEXT, CIRCUIT ID, and CREDIT CARD NUMBER. Normalized data names may be added to the above-listed pre-defined normalized data names.

Column K: Classification. The sensitivity classification of the data element.

Column L: Require Masking. Indicator of whether the data element requires masking. Used in the validation in step 224 (see FIG. 2B) of the data masking process.

Column M: Masking Method. Indicator of the masking method selected for the data element.

Column N: Universal Ind. A Yes (Y) or No (N) that indicates whether each instance of pre-masked data values needs to have universally corresponding post masked values? For example, should each and every occurrence of “SMITH” be replaced consistently with “MILLER”?

Column O: Excessive volume file? A Yes (Y) or No (N) that indicates whether the data file that includes the data element is a high volume file.

Column P: Cross Field Validation. A Yes (Y) or No (N) that indicates whether the data element is validated by the presence/value of other data.

Column Q: Dependencies. A Yes (Y) or No (N) that indicates whether the presence of the data is dependent upon any condition.

Column R: Uniqueness Requirements. A Yes (Y) or No (N) that indicates whether the value of the data element needs to remain unique within the physical file entity.

Column S: Referential Integrity. A Yes (Y) or No (N) that indicates whether the data element is used as a key to reference data residing elsewhere that must be considered for consistent masking value.

Column T: Limited Value Sets. A Yes (Y) or No (N) that indicates whether the values of the data element are limited to valid ranges or value sets.

Column U: Necessity of Maintaining Intelligence. A Yes (Y) or No (N) that indicates whether the content of the data element drives program logic.

Column V: Operational Logic Dependencies. A Yes (Y) or No (N) that indicates whether the value of the data element drives operational logic. For example, the data element value drives operational logic if the value assists in performance/load balancing or is used as an index.

Column W: Valid Data Format. A Yes (Y) or No (N) that indicates whether the value of the data element must adhere to a valid format. For example, the data element value must be in the form of MM/DD/YYYY, 999-99-9999, etc.

Column X: Additional Business Rule. Any additional business rules not previously specified.

### Computing System

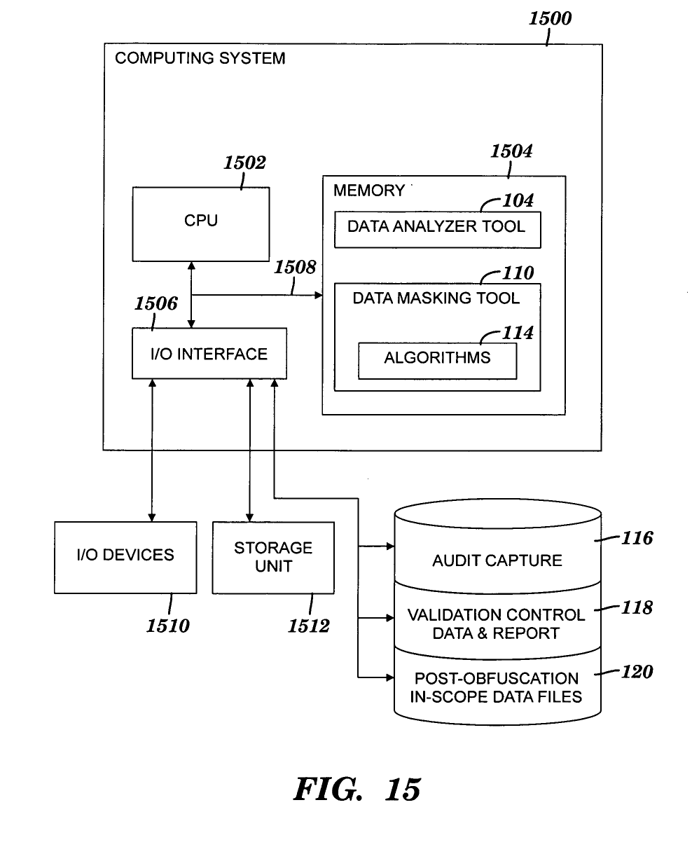

FIG. 15 is a block diagram of a computing system 1500 that includes components of the system of FIG. 1 and that implements the process of FIGS. 2A-2B, in accordance with embodiments of the present invention. Computing system 1500 generally comprises a central processing unit (CPU) 1502, a memory 1504, an input/output (I/O) interface 1506, and a bus 1508. Computing system 1500 is coupled to I/O devices 1510, storage unit 1512, audit capture repository 116, validation control data & report repository 118 and post-obfuscation in-scope data files 120. CPU 1502 performs computation and control functions of computing system 1500. CPU 1502 may comprise a single processing unit, or be distributed across one or more processing units in one or more locations (e.g., on a client and server).

Memory 1504 may comprise any known type of data storage and/or transmission media, including bulk storage, magnetic media, optical media, random access memory (RAM), read-only memory (ROM), a data cache, a data object, etc. Cache memory elements of memory 1504 provide temporary storage of at least some program code in order to reduce the number of times code must be retrieved from bulk storage during execution. Storage unit 1512 is, for example, a magnetic disk drive or an optical disk drive that stores data. Moreover, similar to CPU 1502, memory 1504 may reside at a single physical location, comprising one or more types of data storage, or be distributed across a plurality of physical systems in various forms. Further, memory 1504 can include data distributed across, for example, a LAN, WAN or storage area network (SAN) (not shown).

I/O interface 1506 comprises any system for exchanging information to or from an external source. I/O devices 1510 comprise any known type of external device, including a display monitor, keyboard, mouse, printer, speakers, handheld device, printer, facsimile, etc. Bus 1508 provides a communication link between each of the components in computing system 1500, and may comprise any type of transmission link, including electrical, optical, wireless, etc.

I/O interface 1506 also allows computing system 1500 to store and retrieve information (e.g., program instructions or data) from an auxiliary storage device (e.g., storage unit 1512). The auxiliary storage device may be a non-volatile storage device (e.g., a CD-ROM drive which receives a CD-ROM disk). Computing system 1500 can store and retrieve information from other auxiliary storage devices (not shown), which can include a direct access storage device (DASD) (e.g., hard disk or floppy diskette), a magneto-optical disk drive, a tape drive, or a wireless communication device.

Memory 1504 includes program code for data analyzer tool 104, data masking tool 110 and algorithms 114. Further, memory 1504 may include other systems not shown in FIG. 15, such as an operating system (e.g., Linux) that runs on CPU 1502 and provides control of various components within and/or connected to computing system 1500.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code 104, 110 and 114 for use by or in connection with a computing system 1500 or any instruction execution system to provide and facilitate the capabilities of the present invention. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, RAM, ROM, a rigid magnetic disk and an optical disk. Current examples of optical disks include compact disk—read-only memory (CD-ROM), compact disk—read/write (CD-R/W) and DVD.

Any of the components of the present invention can be deployed, managed, serviced, etc. by a service provider that offers to deploy or integrate computing infrastructure with respect to the method of obfuscating sensitive data while preserving data usability. Thus, the present invention discloses a process for supporting computer infrastructure, comprising integrating, hosting, maintaining and deploying computer-readable code into a computing system (e.g., computing system 1500), wherein the code in combination with the computing system is capable of performing a method of obfuscating sensitive data while preserving data usability.

In another embodiment, the invention provides a business method that performs the process steps of the invention on a subscription, advertising and/or fee basis. That is, a service provider, such as a Solution Integrator, can offer to create, maintain, support, etc. a method of obfuscating sensitive data while preserving data usability. In this case, the service provider can create, maintain, support, etc. a computer infrastructure that performs the process steps of the invention for one or more customers. In return, the service provider can receive payment from the customer(s) under a subscription and/or fee agreement, and/or the service provider can receive payment from the sale of advertising content to one or more third parties.

The flow diagrams depicted herein are provided by way of example. There may be variations to these diagrams or the steps (or operations) described herein without departing from the spirit of the invention. For instance, in certain cases, the steps may be performed in differing order, or steps may be added, deleted or modified. All of these variations are considered a part of the present invention as recited in the appended claims.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A method of obfuscating sensitive data while preserving data usability, comprising:
identifying a scope of a first business application, wherein said scope includes a plurality of pre-masked in-scope data files that include a plurality of data elements, and wherein one or more data elements of said plurality of data elements include a plurality of data values being input into said first business application;
identifying a plurality of primary sensitive data elements as being a subset of said plurality of data elements, wherein a plurality of sensitive data values is included in one or more primary sensitive data elements of said plurality of primary sensitive data elements, wherein said plurality of sensitive data values is a subset of said plurality of data values, wherein any sensitive data value of said plurality of sensitive data values is associated with a security risk that exceeds a predetermined risk level;
selecting a masking method from a set of pre-defined masking methods based on one or more rules exercised on a primary sensitive data element of said plurality of primary sensitive data elements, wherein said primary sensitive data element includes one or more sensitive data values of said plurality of sensitive data values ; and
executing, by a computing system, software that executes said masking method, wherein said executing said software includes masking said one or more sensitive data values, wherein said masking includes transforming said one or more sensitive data values into one or more desensitized data values that are associated with a security risk that does not exceed said predetermined risk level, wherein said masking is operationally valid, wherein a processing of said one or more desensitized data values as input to said first business application is functionally valid, wherein a processing of said one or more desensitized data values as input to a second business application is functionally valid, and wherein said second business application is different from said first business application.

2. The method of claim 1, further comprising:
collecting a plurality of data definitions of said plurality of pre-masked in-scope data files, wherein said plurality of data definitions includes a plurality of attributes that describe said plurality of data elements; and
storing said plurality of attributes in a data analysis matrix managed by a software tool, wherein said storing includes associating, in a one-to-one correspondence, said data elements of said plurality of data elements with said attributes of said plurality of attributes.

3. The method of claim 1, further comprising:
normalizing a plurality of data element names of said plurality of primary sensitive data elements, wherein said normalizing includes mapping said plurality of data element names to a plurality of normalized data element names, and wherein a number of normalized data element names in said plurality of normalized data element names is less than a number of data element names in said plurality of data element names; and
storing, in a data analysis matrix managed by a software tool, a plurality of indicators of said normalized data element names included in said plurality of normalized data element names, wherein said storing includes associating, in a many-to-one correspondence, said data element names of said plurality of data element names with said indicators of said plurality of indicators.

4. The method of claim 1, further comprising:
classifying said plurality of primary sensitive data elements in a plurality of data sensitivity categories, wherein said classifying includes associating, in a many-to-one correspondence, said primary sensitive data elements of said plurality of primary sensitive data elements with said data sensitivity categories of said plurality of data sensitivity categories;
identifying a subset of said plurality of primary sensitive data elements based on said subset of said plurality of primary sensitive data elements being classified, via said classifying, in one or more data sensitivity categories of said plurality of data sensitivity categories, and wherein said primary sensitive data element is included in said subset of said plurality of primary sensitive data elements; and
storing, in a data analysis matrix managed by a software tool, a plurality of indicators of said data sensitivity categories included in said plurality of data sensitivity categories, wherein said storing said plurality of indicators includes associating, in a many-to-one correspondence, said primary sensitive data elements of said plurality of primary sensitive data elements with said indicators of said plurality of indicators.

5. The method of claim 1, wherein said selecting said masking method is included in an obfuscation approach, and wherein said method further comprises validating said obfuscation approach, wherein said validating said obfuscation approach includes:
analyzing a data analysis matrix managed by a software tool, wherein said data analysis matrix includes a plurality of attributes of said plurality of data elements, a first plurality of indicators that indicate said plurality of primary sensitive data elements, a second plurality of indicators that indicates a plurality of normalized data element names to which said plurality of data element names is mapped, a plurality of data sensitivity categories into which said plurality of primary sensitive data elements is classified, and one or more indicators that indicate said one or more rules;
analyzing a diagram of said scope of said first business application, wherein said diagram includes a representation of said plurality of pre-masked in-scope data files; and
adding data to said data analysis matrix, in response to said analyzing said data analysis matrix and said analyzing said diagram.

6. The method of claim 1, further comprising profiling, by a software-based data analyzer tool, a plurality of actual values of said plurality of sensitive data elements, wherein said profiling includes:
identifying one or more patterns in said plurality of actual values; and
determining a replacement rule for said masking method based on said one or more patterns.

7. The method of claim 6, wherein said software-based data analyzer tool is an IBM WebSphere Information Analyzer.

8. The method of claim 1, further comprising developing said software by a software-based data masking tool, wherein said developing said software includes:
creating metadata for a plurality of data definitions of said plurality of pre-masked in-scope data files;
invoking a reusable masking algorithm associated with said masking method; and
invoking a plurality of reusable reporting jobs that report a plurality of actions taken on said plurality of primary sensitive data elements, report any exceptions generated by said method of obfuscating sensitive data, and report a plurality of operational statistics associated with an execution of said masking method.

9. The method of claim 8, wherein said software-based data masking tool is IBM WebSphere DataStage.

10. The method of claim 1, further comprising customizing a design of said software, wherein said customizing includes applying one or more considerations associated with a performance of a job, wherein said executing said software includes executing said job.

11. The method of claim 1, further comprising:
selecting a plurality of masking methods from said set of pre-defined masking methods to transform said plurality of sensitive data values into a plurality of desensitized data values;
developing a plurality of jobs to execute said plurality of masking methods;
developing a first validation procedure to determine that said plurality of jobs is operationally valid; and
developing a second validation procedure to determine that a processing of said plurality of desensitized data values as input to said first business application is functionally valid.

12. The method of claim 11, further comprising executing said first validation procedure, wherein said executing said first validation procedure includes determining that said plurality of jobs is operationally valid.

13. The method of claim 11, further comprising executing said second validation procedure, wherein said executing said second validation procedure includes determining that said processing of said plurality of desensitized data values as input to said first business application is functionally valid.

14. The method of claim 11, further comprising:
executing said plurality of jobs, wherein said executing said plurality of jobs includes transforming said plurality of sensitive data values into said plurality of desensitized data values;
executing said first validation procedure subsequent to said executing said plurality of jobs;
executing said second validation procedure subsequent to said executing said plurality of jobs;
collecting calibration information for a future execution of said plurality of jobs;
archiving a plurality of error logs associated with said plurality of jobs; and
generating an audit trail of said plurality of sensitive data values and said plurality of desensitized data values.

15. The method of claim 1, further comprising storing a diagram of said scope of said first business application as an object in a data analysis matrix managed by a software tool, wherein said diagram includes a representation of said plurality of pre-masked in-scope data files.

16. The method of claim 1, further comprising storing, in a data analysis matrix managed by a software tool, a plurality of indicators of said plurality of primary sensitive data elements.

17. The method of claim 1, further comprising storing, in a data analysis matrix managed by a software tool, one or more indicators of said one or more rules, wherein said storing said one or more indicators of said one or more rules includes associating said one or more rules with said primary sensitive data element.

18. A computing system comprising a processor coupled to a computer-readable memory unit, said memory unit comprising a software application, said software application comprising instructions that when executed by said processor implement the method of claim 1.

19. A computer program product, comprising a computer-usable medium having a computer-readable program code embodied therein, said computer-readable program code comprising an algorithm adapted to implement the method of claim 1.

20. A process for supporting computing infrastructure, said process comprising providing at least one support service for at least one of creating, integrating, hosting, maintaining, and deploying computer-readable code in a computing system, wherein the code in combination with the computing system is capable of performing a method of obfuscating sensitive data while preserving data usability, said method comprising:
identifying a scope of a first business application, wherein said scope includes a plurality of pre-masked in-scope data files that include a plurality of data elements, and wherein one or more data elements of said plurality of data elements include a plurality of data values being input into said first business application;
identifying a plurality of primary sensitive data elements as being a subset of said plurality of data elements, wherein a plurality of sensitive data values is included in one or more primary sensitive data elements of said plurality of primary sensitive data elements, wherein said plurality of sensitive data values is a subset of said plurality of data values, wherein any sensitive data value of said plurality of sensitive data values is associated with a security risk that exceeds a predetermined risk level;
selecting a masking method from a set of pre-defined masking methods based on one or more rules exercised on a primary sensitive data element of said plurality of primary sensitive data elements, wherein said primary sensitive data element includes one or more sensitive data values of said plurality of sensitive data values; and
executing, by said computing system, software that executes said masking method, wherein said executing said software includes masking said one or more sensitive data values, wherein said masking includes transforming said one or more sensitive data values into one or more desensitized data values that are associated with a security risk that does not exceed said predetermined risk level, wherein said masking is operationally valid, wherein a processing of said one or more desensitized data values as input to said first business application is functionally valid, wherein a processing of said one or more desensitized data values as input to a second business application is functionally valid, and wherein said second business application is different from said first business application.

21. A method of obfuscating sensitive data while preserving data usability, comprising:
identifying a scope of a first business application, wherein said scope includes a plurality of pre-masked in-scope data files that include a plurality of data elements, and wherein one or more data elements of said plurality of data elements includes a plurality of data values being input into said first business application;
storing a diagram of said scope of said first business application as an object in a data analysis matrix managed by a software tool, wherein said diagram includes a representation of said plurality of pre-masked in-scope data files;
collecting a plurality of data definitions of said plurality of pre-masked in-scope data files, wherein said plurality of data definitions includes a plurality of attributes that describe said plurality of data elements;
storing said plurality of attributes in said data analysis matrix;
identifying a plurality of primary sensitive data elements as being a subset of said plurality of data elements, wherein a plurality of sensitive data values is included in one or more primary sensitive data elements of said plurality of primary sensitive data elements, wherein said plurality of sensitive data values is a subset of said plurality of data values, wherein any sensitive data value of said plurality of sensitive data values is associated with a security risk that exceeds a predetermined risk level;
storing, in said data analysis matrix, a plurality of indicators of said primary sensitive data elements included in said plurality of primary sensitive data elements;
normalizing a plurality of data element names of said plurality of primary sensitive data elements, wherein said normalizing includes mapping said plurality of data element names to a plurality of normalized data element names, and wherein a number of normalized data element names in said plurality of normalized data element names is less than a number of data element names in said plurality of data element names;
storing, in said data analysis matrix, a plurality of indicators of said normalized data element names included in said plurality of normalized data element names;
classifying said plurality of primary sensitive data elements in a plurality of data sensitivity categories, wherein said classifying includes associating, in a many-to-one correspondence, said primary sensitive data elements included in said plurality of primary sensitive data elements with said data sensitivity categories included in said plurality of data sensitivity categories;
identifying a subset of said plurality of primary sensitive data elements based on said subset of said plurality of primary sensitive data elements being classified in one or more data sensitivity categories of said plurality of data sensitivity categories;
storing, in said data analysis matrix, a plurality of indicators of said data sensitivity categories included in said plurality of data sensitivity categories;
selecting a masking method from a set of pre-defined masking methods based on one or more rules exercised on a primary sensitive data element of said plurality of primary sensitive data elements, wherein said selecting said masking method is included in an obfuscation approach, wherein said primary sensitive data element is included in said subset of said plurality of primary sensitive data elements, and wherein said primary sensitive data element includes one or more sensitive data values of said plurality of sensitive data values;
storing, in said data analysis matrix, one or more indicators of said one or more rules, wherein said storing said one or more indicators of said one or more rules includes associating said one or more rules with said primary sensitive data element;
validating said obfuscation approach, wherein said validating said obfuscation approach includes:
analyzing said data analysis matrix;
analyzing said diagram of said scope of said first business application; and
adding data to said data analysis matrix, in response to said analyzing said data analysis matrix and said analyzing said diagram;
profiling, by a software-based data analyzer tool, a plurality of actual values of said plurality of sensitive data elements, wherein said profiling includes:
identifying one or more patterns in said plurality of actual values, and determining a replacement rule for said masking method based on said one or more patterns;
developing masking software by a software-based data masking tool, wherein said developing said masking software includes:
creating metadata for said plurality of data definitions;
invoking a reusable masking algorithm associated with said masking method; and
invoking a plurality of reusable reporting jobs that report a plurality of actions taken on said plurality of primary sensitive data elements, report any exceptions generated by said method of obfuscating sensitive data, and report a plurality of operational statistics associated with an execution of said masking method;
customizing a design of said masking software, wherein said customizing includes applying one or more considerations associated with a performance of a job that executes said masking software;
developing said job that executes said masking software;
developing a first validation procedure;
developing a second validation procedure;
executing, by a computing system, said job that executes said masking software, wherein said executing said job includes masking said one or more sensitive data values, wherein said masking said one or more sensitive data values includes transforming said one or more sensitive data values into one or more desensitized data values that are associated with a security risk that does not exceed said predetermined risk level;
executing said first validation procedure, wherein said executing said first validation procedure includes determining that said job is operationally valid;
executing said second validation procedure, wherein said executing said second validation procedure includes determining that a processing of said one or more desensitized data values as input to said first business application is functionally valid; and
processing said one or more desensitized data values as input to a second business application, wherein said processing said one or more desensitized data values as input to said second business application is functionally valid, and wherein said second business application is different from said first business application.
